(19) United States
(12) Patent Application Publication
(10) Pub. No.: US 2010/0092809 A1
(43) Pub. Date: Apr. 15, 2010

(54) Electrically conductive, optically transparent films of exfoliated graphite nanoparticles and methods of making the same

(75) Inventors: Lawrence T. Drzal, Okemos, MI (US); Sanjib Biswas, East Lansing, MI (US)

Correspondence Address: Ian C. McLeod;BUTZEL LONG, 2190 Commons Parkway, Okemos, MI, 48864, US

(73) Assignee: Board of Trustees of Michigan State University, East Lansing, MI (US)

(21) Appl. No.: 12/587,645

(22) Filed: Oct. 9, 2009

Related U.S. Application Data
(60) Provisional application No. 61/195,772, filed on Oct. 10, 2008.

(51) Int. Cl. H01M 8/00; B05D 5/12; H01M 10/00; H01M 6/02; B32B 5/00

(52) U.S. Cl. 429/12; 427/58; 204/279; 429/122; 428/220; 428/332; 977/890; 977/952

(57) ABSTRACT

Fabrication techniques are disclosed for the formation of electrically conductive, optically transparent films of exfoliated graphite nanoparticles (EGN). The techniques allow the controlled deposition of EGN nanoplatelets (graphene sheets) and other nanoparticles (e.g., metals, metal oxides) in compact monolayer or multilayer film structures. The compact films have high electrical conductivities and optical transparencies in the visible spectrum of electromagnetic radiation. A first method relates to the deposition of nanoparticles onto a substrate from a bulk suspension using a convective assembly technique. A second method relates to the suspension deposition of EGN nanoplatelets from a from a liquid-liquid interface onto a substrate. Both methods can be used to form EGN film-coated substrates. The second method also can be used to form multilayer, free-standing, defect-free EGN films. The processes have the potential to produce transparent conductors as a replacement for indium tin oxide (ITO) and fluorine tin oxide (FTO) in optoelectronics applications.

### CROSS-REFERENCE TO RELATED APPLICATION

This application claims the priority benefit of U.S. Provisional Application No. 61/195,772, filed Oct. 10, 2008, which is incorporated herein by reference in its entirety.

### BACKGROUND OF THE DISCLOSURE

1. Field of the Disclosure

Fabrication methods are disclosed for the formation of electrically conductive optically transparent films of exfoliated graphite nanoparticles (EGN). The methods allow the controlled deposition of EGN nanoplatelets (graphene sheets) and other nanoparticles (e.g., metals, metal oxides) in compact monolayer or multilayer film structures. The compact films have high electrical conductivities and optical transparencies in the visible spectrum of electromagnetic radiation. A first method relates to the deposition of nanoparticles onto a substrate from a bulk suspension using a convective assembly technique. A second method relates to the suspension deposition of EGN nanoplatelets from a liquid-liquid interface onto a substrate. Both methods can be used to form EGN film-coated substrates. The second method also can be used to form free-standing, defect-free EGN films (e.g., monolayer or multilayer). The processes have the potential to produce transparent conductors as a replacement for indium tin oxide (ITO) and fluorine tin oxide (FTO) in optoelectronics applications.

2. Brief Description of Related Technology

Conventional methods for depositing nanoparticles as a film on a substrate include the “layer by layer” (LBL) self-assembly method and the graphite oxidation (GO) method (described below). The LBL method requires sequential deposition of positively and negatively charged particles in a single cycle or multiple cycles to achieve desired film properties. First, a stable dispersion of hydrophobic nanoparticle (e.g., EGN-exfoliated graphite nanoplatelets—“graphene”) is prepared with the addition of negatively charged polyelectrolyte such as sodium polystyrene sulfonate (SPS) in water. The π-π interaction between the conjugated aromatic ring of the polystyrene moiety and the graphene basal plane makes it possible to produce a stable dispersion of these hydrophobic nanoplatelets in water. For LBL sequential deposition, an oxygen plasma etched glass surface is coated with positively charged polyelectrolyte such as polydiallydimethylammonium chloride (PDAC), followed sequentially by alternatively dipping the glass slide into a water suspension of negatively charged SPS-coated graphene nanoplatelets. Continued deposition of SPS-coated EGN with oppositely charged PDAC builds multilayer structure of desired thicknesses. For EGN, a minimum number of four alternate or bilayer depositions are required to attain electrical conductivity. However, the electrical conductivity increases linearly with sequential deposition and reaches a constant value at about ten layers when a perfectly percolated network between the EGN particles is achieved. Further sequential deposition does not result in any appreciable improvement in electrical conductivity. The requirement of deposition of ten layers of EGN for the formation of percolated network is the result of irregular platelet particle arrangement forming particle contacts between layers and overcoming the platelet separation produced by the polyelectrolyte coating. The irregular packing and the presence of excess of EGN results in low optical transparency as low as 6% in the visible spectrum of electromagnetic radiation.

The LBL deposition method has several disadvantages, namely: (1) the use of polyelectrolytes of opposite polarity prevents direct conductive particle-to-conductive particle contact and formation of a percolated network at minimum particle loading; (2) ten sequential depositions of EGN layers is time-consuming, making the process slow and expensive; (3) excessive amounts of the nanoparticles are required; and (4) the thickness requirements reduce transparency in the visible spectrum.

To apply LBL approach, the EGN needs to be dispersed in the SPS solution in water. To make such dispersion stable, smaller sized platelets are easier to disperse and make for a better quality of dispersion. At the same time the smaller sized platelets are easily attracted to the larger ones and produce a high concentration of agglomerates as verified by FESEM micrographs. On the other hand, larger sized platelets are heavier and are easily deposited even if they interact with the SPS molecules. Thus, the LBL film, made from small-sized platelets, is thicker and its absorbance of electromagnetic radiation from the visible spectrum is high, making the film non-transparent. The agglomeration of small sized platelets also leads to poor connectivity between platelets through out the film. Thus, multiple layers produced through multiple depositions are required to produce an electrically conductive network. At the same time, small-sized platelets create many more points of platelet contact and, therefore, higher contact resistance inside the film. Since the LBL deposition is based on electrostatic or van der Waals force of interaction between charged particles, it is not possible to produce a monolayer of EGN without the incorporation of polyelectrolytes or surfactants inside the EGN film, which polyelectrolytes or surfactants can adversely affect the electrical conductivity of EGN film.

Optoelectronic devices such as display devices (e.g., cathode ray, liquid crystal display, plasma televisions and display devices) often incorporate a transparent conductive coating using indium tin oxide (ITO) or fluorine tin oxide (FTO). However, both FTO and FTO suffer from limited availability, in particular in view of the large volume of electronic display devices being produced. The conventional use of ITO and FTO as a transparent conductor for field effect transistors and optoelectronics applications has several limitations: (1) limited availability of indium; (2) both ITO and FTO have poor chemical stability; (3) both ITO and FTO have poor thermal stability, often preventing integration with other elements at high temperatures; (4) ITO and FTO show ˜80% transparency in the visible spectrum; however, the transparency goes down in the infrared region of the electromagnetic spectrum; (5) current leakage and polymer infusion in ITO and FTO are responsible for degradation of performance during actual operation.

Possible applications for free-standing graphite sheets include: structured carbon electrodes for fuel cells, batteries, and supercapacitors; highly electrically and thermally conductive non-transparent films for electronics; films for reduction in permeability due to the presence of the graphite nanoplatelets; and films to structure devices for hydrogen storage. A conventional method of forming free-standing graphite sheets involves first oxidizing the graphite. Graphene nanoplatelets are highly hydrophobic and difficult to disperse in water even after extended mixing with highly energetic means such as sonication. The very large van der Waals force of attraction between individual graphene nanoplatelets causes them to restack or agglomerate in common solvents. Introducing oxygen functional groups on the basal plane of graphene reduces the aromatic character and the strength of the van der Waals attraction between individual nanoplatelets. In addition, the introduction of oxygen (or other) functional groups like hydroxyl and carboxylic acids on the basal plane also helps to disperse these nanoplatelets in water with or without the help of surfactants or polyelectrolytes by creating a colloidal dispersion. However the oxidation of the graphite basal plane requires intensive chemical treatments with strong oxidizing agents such as potassium chlorate, potassium permanganate or potassium dichromate in the presence of a mixture of highly concentrated sulfuric and nitric acid. This severe oxidative treatment results in the simultaneous creation of multiple defects within the graphene basal plane, thus reducing the quality of the graphene nanoplatelets. The presence of these defects results in a reduction in electrical and thermal conductivity of the graphene nanoplatelet. Reduction of the oxides back to graphite similarly requires dangerous chemical treatment, for example by using hydrazine as a reducing agent.

In general, the current process of making graphene nanoplatelet films utilizes the colloidal suspension of these highly oxidized nanosheets (graphene oxide) and concentrates them by vacuum filtering through an ANODISC membrane filter to produce a thin film of graphite oxide “paper” which is then peeled off and dried in air. The paper shows very high mechanical strength, which is attributed to the hydrogen bond formation among the oxygen functional groups between different layers of graphite oxide. However, this paper is electrically non-conductive due to the presence of these defects or oxygen functional groups. Strong and hazardous reducing agents such as hydrazine are required to remove the oxygen groups to recover the aromatic graphene basal plane. However, this reductive treatment does not fully recover the aromaticity completely, and it also produces the basal plane defects. As a result, the electrical conductivity is lower than expected compared with a pure graphene film. The reductive treatment also reduces the mechanical strength of the film by removing the hydrogen bonds in between graphene sheets.

In one report, the graphite oxide is first reduced in water dispersion with hydrazine and the dispersion was later stabilized by non-covalent functionalization using a water soluble pyrene derivative 1-pyrene butyrate. This pyrene derivative has a strong affinity towards graphene basal plane through π-π interaction. The resulting colloidal suspension in water is then filtered to get pyrene-stabilized graphene paper following the same method as described earlier. In all the experiments mentioned above the modulus of the reduced film was reported to be 4.2 GPa, with an electrical conductivity of about 200 S/cm.

The graphite oxidation method has several disadvantages. For example, a stable dispersion of graphene in water is essential for the graphite oxidation method; however, it requires excessive oxidation and reduction with very strong oxidizing and reducing agents. The associated chemical treatment leaves a high concentration of defects on the graphene basal plane, making it electrically non-conductive or minimally conductive. The defects within the basal plane also reduce the size of the graphene sheets to less than 300 nm in lateral dimension, and the presence of a large number of very small graphene sheets in the final graphene paper introduces a very large contact resistance over large macroscopic areas that adversely affects the electrical conductivity. Additionally, the process of filtration of the colloidal suspension does not allow the perfect alignment of all the nanoplatelets in one plane, instead resulting in an irregular arrangement of nanoplatelets inside the final graphene paper. The inability to control the alignment of graphene nanoplatelet in one direction further affects the electrical conductivity of the graphene paper. The introduction of foreign nanoparticles during the filtration process can not overcome the loss of control in the orientation of the nanoparticles within the nanoplatelet film. Finally, the overall process to prepare graphene paper is very hazardous, expensive, and time-consuming.

### SUMMARY

Two general methods for forming exfoliated graphite nanoparticle (EGN) films are disclosed.

A first method relates to the deposition of nanoparticles onto a substrate from a bulk suspension using a convective assembly technique. The first method has several advantages. For example, deposition of EGN particles in both compact monolayer as well as multilayer structures is possible. The compact and defect-free structure of the film insures high electrical conductivity with very high transparency in the visible spectrum. The method also allows the deposition of EGN particles of various thicknesses. Thus, with reduced EGN thickness, the formation of the compact monolayer and multilayer film structures can be developed to produce transparent and highly conductive films for field effect transistors or optoelectronic applications. The new method requires very small amounts of EGN in suspension to create the monolayer or multilayer film on macroscopic areas of a substrate; thus, the process in inexpensive and can be completed in much less time. This method allows rapid deposition of EGN particles over large macroscopic areas in a single step. No specialized equipment is required for implementation. The technique can also be applied to other nanoparticles such as carbon nanotubes or metal oxide nanoparticles to get highly dispersed compact monolayers of nanoparticle networks on glass or other substrates.

A second method relates to the formation of EGN nanoplatelet monolayers at a liquid-liquid interface from a suspension of EGN nanoplatelets, for example for deposition onto a substrate or for creation of free-standing mono-/multilayered films. The second method also has several advantages. For example, a monolayer film of EGN can be prepared from the larger sized platelets with a characteristic width dimension of more than 15 μm. With the use of the larger diameter platelets, agglomerations of small-sized platelets can be avoided. Larger sized platelets also are very effective at producing interconnected networks inside the film with much lower electrical contact resistance, thus improving the electrical conductivity. Additionally, polyelectrolytes or surfactants are not required in the second method, a feature that further improves the film's electrical conductivity. The absence of polyelectrolytes or surfactants ensures the highest electrical and chemical resistivity approaching that of the parent graphite or EGN material. The monolayer film formed with this method is much thinner and produces not only higher electrical conductivity but also much higher transparency both in the visible and the infrared spectrum of electromagnetic radiation. The method is very easy and quick; it can be scaled to producing films of very large lateral dimensions without any alteration of the process.

The second method has additional advantages, in particular in relation to the graphite oxidation method. Specifically, no chemical transformation of graphene basal plane is required and thus the native properties of graphene are not compromised. Instead of chemically functionalizing graphene and then dispersing it in water, the disclosed method applies a liquid-liquid interfacial self assembly method of highly hydrophobic nanoplatelets to make a highly dispersed, compact monolayer film of graphene at the liquid-liquid interface. Only two readily available fluids are used in the process (e.g., water and chloroform) as the two immiscible liquids, thereby not requiring any other chemical that interacts with the graphene basal plane. Thus, the process is simple and non-hazardous. With the absence of any other foreign materials, the native properties of graphene remain intact, and the resulting graphene film has a very high electrical conductivity. The high electrical conductivity of graphene, prepared from this approach, makes this highly desirable as an electrode material for energy storage devices applications. The use of this method creates chemically pure graphene of very large sized nanoplatelets with minimum contact resistance between individual nanoplatelets. The graphene paper film is flexible and can be cut in any desirable shapes for final applications. This new method is based on creating multilayers of graphene nanoplatelets from monolayer films of graphene. The strong van der Waals force of attraction between the nanoplatelets keeps those well attached with each other, making a free standing film of graphene. The advantage of this multilayered approach allows the perfect alignment of nanoplatelets in one direction, which contributes towards better structural stability as well as electrical and thermal conductivity. The increased degree of alignment of the nanoplatelets is reflected by the optical microscopy characterization of the resulting film (e.g., as deposited on a glass slide or other substrate, or as a free-standing film). When nanoplatelets are not lying flat and/or are not otherwise aligned with the plane define by the film, then there is an increasing degree of nanoplatelet overlap, resulting in a reduced the transparency of the film at a given thickness (i.e., because the transparency of the macroscopic film is dependent on the thickness of the individual nanoplatelets forming the film). Similarly, when nanoplatelets are deposited on top of a silicon wafer substrate, then reflectance microscopy characterization relates the thickness of the sample from the homogeneity of the nanosheet appearance (e.g., color) at different sections. Highly aligned nanoplatelet films have a homogeneous color, although the specific color is a function of film thickness. The high degree of alignment property also applies to films formed according to the first bulk suspension/convective evaporation method. In the convective evaporation technique, the platelets lay flat on a solid substrate; however, there can be overlap between some platelets due to the convective transport of particles to the meniscus edge during film formation. If thin (<5 nm) graphene nanoplatelets are used in the process, it is also possible to create a multilayer free-standing transparent film. This method is very easy and quick, and it can be scaled to producing films of very large lateral dimensions without any alteration of the process.

Specific compositions and processes related to the above two methods are described in more detail below.

Disclosed herein is an exfoliated graphite nanoparticle (EGN) film comprising: an EGN film having a thickness ranging from about 0.2 nm to about 20 nm. In various embodiments, the thickness can range from about 0.3 nm to about 10 nm, for example up to about 2 nm, 4 nm, 6 nm, or 8 nm and/or at least about 0.3 nm, 0.5 nm, 1 nm, or 2 nm. The EGN film can be in the form of a monolayer of EGN platelets or a multilayer of EGN platelets (e.g., a plurality of monolayers). Preferably, the EGN film has an electrical conductivity of at least about 80 S/cm (e.g., as determined by a two-point or four-point impedance probe method) and a transparency in the visible electromagnetic spectrum of at least about 25%. More preferably, the electrical conductivity is at least about 100 S/cm (e.g., about 80 S/cm to about 3000 S/cm, about 100 S/cm to about 2000 S/cm, about 100 S/cm to about 500 S/cm, about 500 S/cm to about 2000 S/cm, or about 800 S/cm to about 1500 S/cm). Similarly, the transparency is more preferably at least about 50% (e.g., at least about 70%, 80%, or 90%) at various visible and/or infrared electromagnetic wavelength (e.g., at about 500 nm, about 1000 nm, about 1500 nm, and/or up to about 2000 nm).

In an embodiment of the exfoliated graphite nanoparticle (EGN) film, the EGN film comprises: (a) a monolayer EGN film comprising (i) exfoliated graphite nanoparticles (e.g., forming a close-packed structure in the monolayer EGN film) and (ii) a first polyelectrolyte distributed throughout the monolayer EGN film, or (b) a multilayer EGN film comprising a plurality of the monolayer EGN films (e.g., each with the exfoliated graphite nanoparticles and the polyelectrolyte) arranged in a layered configuration. The layered configuration for the multilayer EGN film can include monolayer EGN films that are sequentially layered upon each other, with or without intervening layers of other substances (e.g., as in a layered composite including monolayer EGN films and other materials). The monolayer EGN film can be characterized as having (either alone as a constituent component of the multilayer EGN film): (i) a thickness ranging from about 0.2 nm to about 20 nm (e.g., about 0.3 nm to about 20 nm, about 0.3 nm to about 10 nm); (ii) an electrical conductivity of at least about 80 S/cm (e.g., at least about 100 S/cm); and/or (iii) a transparency in the visible electromagnetic spectrum of at least about 25% (e.g., at least about 50% at a wavelength of about 500 nm). As the exfoliated graphite nanoparticles forming the monolayer EGN film suitably have not been intentionally oxidized through a graphite oxidation process, the resulting monolayer EGN film can have a carbon content of at least about 90 wt % and/or an oxygen content of about 10 wt. % or less. Whether in the form of a monolayer or multilayer EGN film, the film can be (i) in the form of a free-standing film or (ii) coated on a substrate, the substrate comprising a second polyelectrolyte deposited on a surface of the substrate, the second polyelectrolyte being oppositely charged to the first polyelectrolyte.

In another embodiment of the exfoliated graphite nanoparticle (EGN) film, the EGN film comprises: (a) a monolayer EGN film comprising exfoliated graphite nanoparticles (e.g., forming a close-packed structure in the monolayer EGN film), or (b) a multilayer EGN film comprising a plurality of the monolayer EGN films arranged in a layered configuration. The layered configuration for the multilayer EGN film can include monolayer EGN films that are sequentially layered upon each other, with or without intervening layers of other substances (e.g., as in a layered composite including monolayer EGN films and other materials). The monolayer EGN film can be characterized as having (either alone as a constituent component of the multilayer EGN film): (i) a thickness ranging from about 0.2 nm to about 20 nm (e.g., about 0.3 nm to about 20 nm, about 0.3 nm to about 10 nm); (ii) an electrical conductivity of at least about 100 S/cm (e.g., at least about 500 S/cm); and/or (iii) a transparency in the visible electromagnetic spectrum of at least about 35% (e.g., at least about 50% at a wavelength of about 500 nm). As the exfoliated graphite nanoparticles forming the monolayer EGN film suitably have not been intentionally oxidized through a graphite oxidation process, the resulting monolayer EGN film can have a carbon content of at least about 90 wt % and/or an oxygen content of about 10 wt. % or less. Whether in the form of a monolayer or multilayer EGN film, the film can be (i) in the form of a free-standing film or (ii) coated on a substrate.

In an additional embodiment, any of the disclosed EGN films can be in the form of a free-standing film. The free-standing film can be in the form of an EGN monolayer film or a plurality of EGN monolayer films sequentially layered in a multilayer structure. In either case, the mono- or multilayer films can have an electrical conductivity of at least about 500 S/cm (e.g., at least about 800 S/cm or about 1000 S/cm and/or up to about 1500 S/cm or about 2000 S/cm). Preferably, the multilayer structure has a storage modulus of at least about 2 GPa (e.g., at least about 3 GPa and/or up to about 5 GPa or about 8 GPa). The EGN film can be in the form of a composite film, for example comprising a second nanoparticle monolayer adhered to the free-standing film, where the second nanoparticle is preferably selected from the group consisting of metal nanoparticles, metal oxide nanoparticles, and combinations thereof.

In yet another embodiment, any of the disclosed EGN films can be included in a EGN film-coated substrate that comprises a substrate (e.g., a silicon substrate, a glass substrate, a metal substrate) and the EGN film coated thereon. In a refinement, the substrate comprises a first polyelectrolyte deposited on a surface of the substrate in contact with the EGN film, and the EGN film comprises a second polyelectrolyte distributed therein, the second polyelectrolyte being oppositely charged to the first polyelectrolyte. In this case, the first polyelectrolyte preferably comprises a poly(diallyldimethyl ammonium) salt (e.g., a chloride salt, “PDAC”) and the second polyelectrolyte preferably comprises a polystyrene sulfonate salt (e.g., a sodium salt, “SPS”).

The disclosed monolayer and multilayer EGN films, whether in free-standing form or as applied to a substrate, can be integrated into a variety of apparatus. In one embodiment, an optoelectronic device can include any of the foregoing EGN film-coated substrates (e.g., a flat panel display device selected from the group consisting of liquid crystal displays and plasma displays). In another embodiment, an energy storage device can include an electrode comprising any of the foregoing EGN films or EGN film-coated substrates.

Also disclosed is a process for forming a nanoparticle film-coated substrate. The process comprises: (a) providing a substrate assembly comprising a first substrate and a second substrate at a preselected distance from the first substrate, wherein (i) the first and second substrates define an interstitial space therebetween and (ii) the first substrate further comprises a first polyelectrolyte deposited on a surface of the first substrate facing the interstitial area; (b) providing a deposition dispersion comprising a liquid medium (e.g., water), a second polyelectrolyte oppositely charged to the first polyelectrolyte, and nanoparticles dispersed therein; (c) filling the interstitial space with the deposition dispersion; and, (d) evaporating the liquid medium in the interstitial space, thereby (i) depositing the nanoparticles as a film on the surface of the first substrate having the first polyelectrolyte and (ii) forming a nanoparticle film-coated substrate. The first substrate and the second substrate can be independently selected from the group consisting of a silicon substrate, a glass substrate, a polymer substrate, a cellulosic substrate, and a metal substrate. Preferably, the first polyelectrolyte comprises a poly(diallyldimethyl ammonium) salt (e.g., a chloride salt, “PDAC”) and the second polyelectrolyte comprises a polystyrene sulfonate salt (e.g., a sodium salt, “SPS”). The nanoparticles are preferably selected from carbon nanotubes, metal nanoparticles, metal oxide nanoparticles, and/or exfoliated graphite nanoparticles (EGN, in which case the nanoparticle film preferably has an electrical conductivity of at least about 80 S/cm as determined by a two-point impedance probe method and a transparency in the visible electromagnetic spectrum of at least about 25%). Preferably, the preselected distance is sufficiently small so that filling the interstitial space with the deposition dispersion occurs by capillary action (e.g., the preselected distance ranges from about 10 μm to about 500 μm, about 50 μm to about 300 μm, or about 100 μm to about 200 μm). The deposition dispersion preferably has a concentration of nanoparticles that is sufficiently large so that the resulting nanoparticle film is substantially continuous and suitably a continuous, compact monolayer or multilayer structure (e.g., at least about 0.02 wt. %, at least about 0.05 wt. %, or at least about 0.1 wt. % and/or up to about 0.5 wt. % or 1 wt. % nanoparticles in the deposition dispersion). In a refinement, the process further comprises, prior to evaporating the liquid medium, orienting the substrate assembly so that a normal vector (e.g., outwardly pointing) from the surface of the first substrate having the first polyelectrolyte is substantially aligned with but opposite in direction to gravity. In yet another refinement, the substrate assembly comprises an array of a plurality of substrates in which each substrate comprises the first polyelectrolyte on a surface so that each interstitial space defined by a pair of adjacent substrates is bounded by at least one surface comprising the first polyelectrolyte deposited thereon.

Also disclosed is a process for forming an exfoliated graphite nanoparticle (EGN) film. The process comprises: (a) providing a suspension formulation comprising a hydrophobic liquid medium (e.g., chloroform, methylene chloride) and EGN platelets dispersed therein; (b) mixing an immiscible, hydrophilic liquid (e.g., water) with the suspension formulation; and (c) concentrating the EGN platelets as a monolayer at a liquid-liquid interface between the hydrophobic liquid and the hydrophilic liquid, thereby forming a free-standing monolayer EGN film. Preferably, the suspension formulation has a concentration of EGN platelets that is sufficiently small to substantially prevent agglomeration and coalescence of the EGN platelets (e.g., about 0.0001 wt. % to about 0.1 wt. %, about 0.0002 wt. % to about 0.05 wt. %, or about 0.0005 wt. % to about 0.01 wt. % of EGN platelets in the suspension formulation). The resulting film preferably has an electrical conductivity of at least about 500 S/cm (e.g., at least about 800 S/cm or 1000 S/cm and/or up to about 2000 S/cm or 3000 S/cm) as determined by a two-point impedance probe method and a transparency in the visible electromagnetic spectrum of at least about 25% (e.g., at least about 50%, 70%, 80%, or 90%, for example at a wavelength of about 500 nm, at a range of wavelengths from about 500 nm to about 2000 nm, and/or generally in the infrared electromagnetic spectrum). In a refinement, mixing the hydrophilic liquid with the suspension formulation comprises sonicating the hydrophilic liquid and the suspension formulation, thereby forming an emulsion between the hydrophobic liquid and the hydrophilic liquid; and concentrating the EGN platelets comprises allowing the emulsion to separate, thereby forming separate hydrophobic liquid and hydrophilic liquid phases and accumulating the EGN platelets at the liquid-liquid interface.

In another refinement of the process, the process further comprises depositing the monolayer EGN film on a substrate (e.g., a silicon substrate, a glass substrate, a polymer substrate, a cellulosic substrate, and a metal substrate), thereby forming an EGN film-coated substrate. Preferably, depositing the EGN platelet monolayer comprises: pulling the substrate through one liquid phase (e.g., the hydrophobic liquid) to the second liquid phase (e.g., the hydrophilic liquid), thereby depositing the monolayer EGN film on the substrate as the substrate passes through the liquid-liquid interface. Depositing the EGN platelet monolayer can alternatively comprise: (i) transferring at least a portion of the monolayer EGN film and the hydrophobic liquid from the liquid-liquid interface to a gas-liquid interface between the hydrophilic liquid and a gaseous external environment (e.g., ambient air); (ii) evaporating the hydrophobic liquid at the gas-liquid interface, leaving the monolayer EGN film at the gas-liquid interface; and, (iii) pulling the substrate through the hydrophilic liquid to the gaseous external environment, thereby depositing the monolayer EGN film on the substrate as the substrate passes through the gas-liquid interface. In some embodiments, the EGN film-coated substrate can be annealed, and the EGN film-coated substrate can be immersed in the same or a different hydrophilic liquid until the EGN film separates from the substrate, thereby forming a free-standing monolayer EGN film. In other embodiments, the process additionally comprises: annealing the EGN film-coated substrate; repeating the steps of (i) providing a suspension formulation comprising a hydrophobic liquid medium and EGN platelets dispersed therein, (ii) mixing an immiscible, hydrophilic liquid with the suspension formulation, and (iii) concentrating the EGN platelets as a monolayer EGN film at a liquid-liquid interface between the hydrophobic liquid and the hydrophilic liquid; and depositing and annealing the monolayer EGN film on the EGN film-coated substrate, thereby forming a multilayer EGN film-coated substrate (which can be subsequently immersed in the hydrophilic liquid until the multilayer EGN film separates from the substrate, thereby forming a free-standing multilayer EGN film).

In any of the foregoing embodiments, the thickness of the EGN platelets can range from about 0.2 nm to about 20 nm or about 0.3 nm to about 10 nm, for example up to about 2 nm, 4 nm, 6 nm, or 8 nm and/or at least about 0.3 nm, 0.5 nm, 1 nm, or 2 nm. The EGN platelets can have widths ranging from about 1 μm to about 20 μm, about 2 μm to about 15 μm, or about 3 μm to about 10 μm. Thus, the EGN platelets preferably have a width-to-thickness aspect ratio of at least about 100, for example at least about 1,000 or 2,000 and/or up to about 5,000 or 10,000. The EGN platelets can be used to form of either a monolayer of EGN platelets (e.g., having a close packed structure) or a multilayer of EGN platelets (e.g., a plurality of monolayers).

The EGN films disclosed herein are ideal, inexpensive substitutes for ITO and FTO in optoelectronic applications and are useful in solar cells, in particular when in the form of a thin transparent monolayer film. Graphite is one of the most abundant materials on earth, and EGN is easily produced. Both monolayer and multilayer films produced according to the disclosure have high electrical conductivity, thermal conductivity, and optical transparency. Additionally, EGN is highly resistant to both chemical and thermal treatments; therefore, it can combine with other elements even at temperatures as high as 400° C. and can withstand environmental exposure. The graphene basal plane of graphene nanoplatelets is chemically pure without any defects. The EGN films have relatively flat transmission profiles in both the visible and infrared region of electromagnetic spectrum. This property is desirable for many applications. The EGN film is highly electrically conductive with the reported electrical resistivity of graphene sheet as high as 50×10⁻⁶ ohm-cm. Additionally, a monolayer film of EGN has tremendous potential in optoelectronics application, considering its only 2% transmission loss from the visible spectrum for a single graphene sheet. The methods also can produce EGN films having a characteristic width up to several meters (e.g., up to about 1 m to 5 m).

The disclosed EGN films are highly electrically conductive, flexible thin films that also can be used for alternative energy storage. For example, the flexible EGN films can be cut in any shapes; yet the mechanical properties (e.g., stiffness, tensile modulus) of the free standing film is still sufficiently high (e.g., close to 4 GPa), which is ideal for many applications. Different energy storage applications such as supercapacitors, lithium ion storage batteries, fuel cell systems, hydrogen storage devices, thermoelectric materials, etc. utilize a highly conductive carbon nanomaterial electrode to facilitate the flow of electrons into or out of the system. Carbon nanotubes are one of the promising materials in these applications. However, the limited availability of inexpensive and high purity nanotubes limits their use in such storage applications. High purity and inexpensive graphene nanoplatelet material in the form of an EGN film according to the disclosure is thus a potential alternative. With the growing interest in application of supercapacitors in the automobile market, the demand is expected to reach more than $7 billion by year 2008. At the same time, the use of thin film lithium ion batteries is anticipated to reach $11 billion by year 2011. The use of free-standing films of graphene can also benefit the hydrogen storage capacity at the nanoscale. The estimated market for hydrogen storage material is expected to reach more than $1.6 billion by the year 2010.

Additional features of the disclosure may become apparent to those skilled in the art from a review of the following detailed description, taken in conjunction with the drawings, examples, and appended claims.

### BRIEF DESCRIPTION OF THE DRAWINGS

For a more complete understanding of the disclosure, reference should be made to the following detailed description and accompanying drawings wherein:

FIG. 1 is a cross-sectional view of an exfoliated graphite nanoparticle (EGN) film-coated substrate according to the disclosure.

FIG. 2 is a cross-sectional view of a substrate assembly for use in a process of forming a nanoparticle film-coated substrate according to the disclosure.

FIG. 3 is a cross-sectional view of the substrate assembly of FIG. 2 oriented to facilitate deposition of the nanoparticle film during an evaporation step of the process.

FIG. 4 illustrates a process of forming an EGN platelet monolayer according to the disclosure.

FIGS. 5a-5c illustrate an EGN film produced according to the disclosure. FIG. 5a is an optical microscopy image of the EGN film having an optical transparency of 25%. FIG. 5b is a scanning electron micrograph of the same film, showing the highly compact nature and interconnection between the platelets within the film. FIG. 5c is a comparison of the electrical conductivity and the optical transparency (at 500 nm) of the film.

FIGS. 6a and 6b are FESEM images of graphene nanosheets deposited on cellulose acetate filter membranes. The average size of the nanosheet is estimated to be 8 to 10 μm (scale bar: 2 μm).

FIG. 7 illustrates the adsorption of graphene nanosheets at the liquid interface. (a) Distinct phases of two pure liquids, chloroform and water, in contact with each other. (b) Graphene nanosheets are dispersed in the chloroform phase and water is added on the top to get two distinct phases with graphene nanosheets dispersed in the chloroform phase. This two-phase mixture is then briefly sonicated to adsorb the nanosheets at the liquid-liquid interface. (c) Film of graphene nanosheets covering the liquid-liquid interface and then extending up the chloroform glass interface. On the marked area of panel c, a part of the film has been cracked with a spatula to show the liquid inside.

FIG. 8 illustrates the free energy of particle detachment, showing the variation in free energy of detachment of the particle as a function of contact angle (θ). The particle thickness and width are 4 nm and 10 micron, respectively.

FIG. 9 illustrates a monolayer film of graphene nanosheets. (a-d) FESEM micrographs of graphene nanosheets deposited on the glass slide. The specimen was sputter coated with gold to get better contrast on the image. Images, taken from different areas, clearly exhibit how the planar nanosheets are interconnected with each other. Without coming on top of each other, nanosheets are well interconnected, forming a monolayer over the large area of the substrate. The arrows, shown in the images, indicate the edge of nanosheets.

FIG. 10 illustrates multiple images of the graphene nanosheet film. (a) The metallic luster of graphene nanosheet film under white light. The film is deposited on microscopic glass slide. (b,c) Optical microscopy images of film prepared from two different nanosheet thicknesses. Numerous dark spots in panel b give clear evidence of the presence of thicker nanosheets of average thickness of 10 nm. Under similar condition, film prepared from thinner nanosheets of an average thickness of 3 to 4 nm shows much higher transparency as shown in panel c. The scale bar is 500 μm. (d) Low-magnification TEM image. The scale bar is 20 μm. (e) High-magnification TEM micrograph explains the morphology of the film with individual nanosheets touching each other at the edges without any complete overlap. The scale bar is 100 nm. The arrows indicate how two individual nanosheets are interconnected through the edges.

FIG. 11 illustrates the optical transparency of the film as a function of film thickness and optical wavelength. Optical transmission spectra from 500 to 2000 nm are shown for monolayer films of graphene nanosheets at various nanosheet thicknesses.

FIG. 12 illustrates differences between films having varying numbers of layers. As shown in FIG. 12a from left to right, stable monolayer, bilayer, and multilayer (four layers) films were deposited on glass substrate (scale bar: 1 cm). Under the marked arrow in the middle slide, two monolayer films were deposited one top of another to create a stable bilayer structure. The optical transparency also decreases linearly with increasing number of depositing layers. FIGS. 12b-12d illustrate the FESEM morphological characterization of the mono-, bi-, and multi-layer films in FIG. 12a, respectively (scale bar: 20 μm). A substantial overlap between nanosheets was observed from the monolayer to multilayer configuration.

FIG. 13 illustrates the morphology of the multilayer, free-standing film. (a,b) The film is flexible and can be bent or rolled (scale bar: 1 cm). (c) FESEM micrograph clearly shows a crumpled film without the formation of large fragments or cracks (scale bar: 500 μm). (d, e, f) Films of various thicknesses from less than 5 um to more than 50 μm were formed (scale bar: 20, 20 and 100 μm, respectively).

While the disclosed apparatus and processes are susceptible of embodiments in various forms, specific embodiments of the disclosure are illustrated in the drawings (and will hereafter be described) with the understanding that the disclosure is intended to be illustrative, and is not intended to limit the claims to the specific embodiments described and illustrated herein.

### DETAILED DESCRIPTION

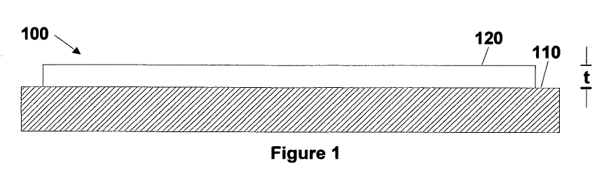

The disclosed methods are generally used to produce exfoliated graphite nanoparticle (EGN) films, for example as a free-standing film or as a coating on a substrate as illustrated in FIG. 1. In FIG. 1, an exfoliated graphite nanoparticle (EGN) film-coated substrate 100 includes a substrate 110 (e.g., glass, silicon, metal (for example stainless steel, nickel)) and an EGN film 120 coated on the substrate 100. Alternatively, the EGN film can be a free-standing film. In either case, the EGN film can be a monolayer film or a multilayer film. The thickness t of the EGN film 120 (illustrated in FIG. 1, but also applicable to free-standing films) is not particularly limited, for example depending on whether the film is a multilayer or monolayer film. The number of layers is not restricted to any set number. The films can be made as thick as desired based on the application. In general, for optical transmission, a single layer of graphene loses about 2% transmission in the visible spectrum. Therefore, once a film approaches about 50 layers in thickness (i.e., about 16 nm) it does not substantially transmit visible light. The film thickness t can suitably be up to about 20 nm, for example ranging from about 0.2 nm to about 20 nm or about 0.3 nm to about 10 nm. In various embodiments, the thickness can be up to about 2 nm, 4 nm, 6 nm, or 8 nm and/or at least about 0.3 nm, 0.5 nm, 1 nm, or 2 nm. In embodiments where transparency of the film is not a required or desired property, the film thickness can be larger and have any suitable value (i.e., based on the number of layers forming the film), for example up to about 50 nm, 80 nm, or 100 nm and/or at least about 5 nm, 10 nm, or 20 nm. The disclosed EGN films do not require a matrix or binder material (e.g., polymer, carbon, ceramic, glass) to maintain a cohesive film structure. Thus, the EGN film preferably has exfoliated graphite as its substantial constituent (e.g., at least about 80 wt. %, 90 wt. %, 95 wt. %, 98 wt. %, or 99 wt. % of the EGN film is graphite).

The graphite material generally can include natural graphite, synthetic graphite, and/or highly oriented pyrolitic graphite. An expanded graphite is one which has been heated to separate individual platelets of graphite. An exfoliated graphite is a form of expanded graphite where the individual platelets are separated by heating with or without an agent (e.g., a polymer or polymer component). The graphite can be heated with conventional (thermal) heating, microwave (MW) energy, or radiofrequency (RF) induction heating. The microwave and radiofrequency methods provide a fast and economical method to produce exfoliated graphite. The combination of microwave or radiofrequency expansion and an appropriate grinding technique (e.g., planetary ball milling, vibratory ball milling), efficiently produces nanoplatelet graphite flakes with a high aspect ratio (e.g., up to 100, 1000, 10,000 or higher), a high surface area (e.g., at least about 50 m²/g, about 75 m²/g, or about 100 m²/g and/or up to about 150 m²/g, about 200 m²/g, and/or about 300 m²/g), and a controlled size distribution. Chemically intercalated graphite flakes are rapidly exfoliated by application of the microwave or radiofrequency energy, because the graphite rapidly absorbs the energy without being limited by convection and conduction heat transfer mechanisms. For example, microwave heating for up to 5 minutes (e.g., and for times as low as about 1 second) exfoliates the graphite and removes/boils the expanding intercalating chemical.

The graphite material suitably has not been oxidized, and thus contains only a minor amount of oxygen in the carbon network (e.g., resulting from natural oxidation processes and/or mechanical size reduction processes). As a result, the EGN film formed from the graphite material also has a minor amount of oxygen. When used in the liquid-liquid interfacial formation method, the graphite material should have a low enough oxygen content that it is insoluble in the hydrophilic (water) phase, also taking into account the effect of particle size on solubility. Suitably, the EGN film (or starting graphite material) contains less than about 10%, 8%, 5%, or 3% oxygen (on a number or weight basis), although residual amounts of oxygen ranging from about 0.1%, about 1%, or about 3% or more are not uncommon at the lower end. Similarly, the EGN film (or starting graphite material) can be characterized as containing at least about 90%, 92%, 95%, or 97% carbon (on a number or weight basis).

The exfoliated graphite nanoparticle (EGN) material according to the disclosure generally includes a single graphene sheet or multiple graphene sheets stacked and bound together. Each graphene sheet, also referred to as a graphene plane or basal plane, has a two-dimensional hexagonal lattice structure of carbon atoms. Each graphene sheet has a length and a width (or, equivalently, an approximate diameter) parallel to the graphene plane and a thickness (e.g., an average thickness) orthogonal to the graphene plane. Particle diameters generally range from the sub-micron level to over 100 microns (e.g., about 0.1 μm to about 1 mm; such as about 1 μm to about 20 μm, about 2 μm to about 15 μm, about 3 μm to about 10 μm; alternatively or additionally about 5 μm to about 100 μm, about 8 μm to about 80 μm, about 10 μm to about 50 μm). The thickness of a single graphene sheet is about 0.3 nm (e.g., 0.34 nm). Individual EGN particles (or platelets) used herein can include either single graphene sheet or multiple graphene sheets, and thus the thickness of the EGN particles can generally range from about 0.2 nm or about 0.3 nm to about 20 nm, or about 0.3 nm to about 10 nm (e.g., up to about 2 nm, 4 nm, 6 nm, or 8 nm and/or at least about 0.3 nm, 0.5 nm, 1 nm, or 2 nm). Alternatively, the thickness of the EGN particles can be expressed in term of the number of stacked graphene sheets they contain, for example 1 to 60 or 1 to 30 (e.g., 2 to 50, 3 to 40, or 5 to 30). The EGN platelets preferably have an aspect ratio of at least about 100, for example at least about 1,000 or 2,000 and/or up to about 5,000 or 10,000. The aspect ratio can be defined as the diameter-to-thickness ratio or the width-to-thickness ratio (e.g., with the width being a characteristic (such as average or maximum) dimension in the graphene plane). A population of EGN platelets (or other nanoparticles) can have a distribution of characteristic size parameters (e.g., diameter, thickness, aspect ratio), and the various size ranges can generally apply to the boundaries of the distribution (e.g., upper and lower boundaries such as 1%, 5%, or 10% lower and/or 90%, 95%, or 99% upper cumulative distribution boundaries) and/or the average of the distribution, where the distribution can be based on number, volume, or mass. Suitable EGN particles are available from XG Sciences, Inc. (East Lansing, Mich.) and generally have a thickness of about 5 nm (e.g., average thickness of about 4 nm to 6 nm with a thickness distribution ranging from about 1 nm to about 15 nm)

As used herein, a monolayer of EGN particles refers to a layer of EGN particles having a thickness substantially corresponding to that of single EGN particles. However, the EGN particles can include those with multiple graphene sheets, so a monolayer can still represent a film having a thickness equivalent to multiple graphene sheets. Similarly, a multilayer of EGN particles refers to a layer of EGN particles having a thickness substantially corresponding to that of multiple, stacked EGN particles (e.g., a plurality of EGN monolayers that are serially stacked). The processes disclosed herein that are suitable for forming EGN monolayers are also generally applicable to the formation of EGN multilayers, for example by performing multiple processes in series. Thus, the number of layers in an EGN multilayer is not particularly limited. The optical transparency of the EGN multilayer generally increases with fewer layers. Conversely, the mechanical strength of the multilayer generally increases with more layers. Preferably, the EGN multilayer contains up to about 10 layers (e.g., 2 to 4, 2 to 6, or 7 to 10).

In the various embodiments, the EGN film (whether free or on a substrate) is generally electrically conductive and optically transparent. The EGN film generally has an electrical conductivity of at least about 80 S/cm as determined by a two-point or four-point impedance probe method and a transparency in the visible and/or infrared electromagnetic spectrum of at least about 25% or 35% (e.g., 380 nm to 750 nm, at about 500 nm, and/or about 750 nm to about 2000 nm). Preferably, the EGN film has an electrical conductivity of at least about 100 S/cm (e.g., at least about 300 S/cm, at least about 500 S/cm, up to about 1500 S/cm, up to about 2000 S/cm, and/or up to about 3000 S/cm, for example including ranges such as about 80 S/cm to about 3000 S/cm, about 100 S/cm to about 2000 S/cm, about 100 S/cm to about 500 S/cm, about 500 S/cm to about 2000 S/cm, or about 800 S/cm to about 1500 S/cm), with higher conductivities generally being obtained in polyelectrolyte-free films (e.g., those formed with a liquid-liquid interfacial film process) and/or thicker films. The EGN film preferably has a transparency of at least about 35% or 50% (e.g., at least about 70%, 80%, or 90%), with higher transparencies generally being obtained with thinner films and/or films with fewer EGN layers. Conductivity measurements can be performed with a femtostat three-electrode system (available from Gamry). The sheet resistance can be measured using four-point probe set up (e.g., with a SOURCEMETER 2400, available from Keithley). The transparency of the film can be determined using Perkin Elmer LAMBDA 900 UV spectrometer.

The disclosed film-formation methods (e.g., bulk suspension, liquid-liquid interface) can be applied to other nanoparticles either in addition to or instead of exfoliated graphite nanoparticles. Other suitable nanoparticles can include carbon-based nanoparticles (e.g., nanotubes, graphite), ceramic, clay, or metal-based nanoparticles (e.g., metals, metal-containing compounds, metal alloys, oxides thereof). The metals in the nanoparticles are not particular limited, with suitable examples including tin and indium (e.g., indium tin oxide (ITO), fluorine-doped tin oxide (FTO)). The nanoparticles suitably have at least one characteristic dimension that is on the nanometer-scale, for example ranging from about 0.1 nm, 0.3 nm, or 1 nm to about 10 nm, 50 nm, or 100 nm. The nanoparticles can have any desired shape, for example including a granular (e.g., semi-spherical), an oblate (e.g., disk- or flake-shaped), or a prolate (e.g., rod- or cylinder-shaped) shape. Other particles used in the liquid-liquid interfacial film formation method suitably are platelets (e.g., generally oblate) having both hydrophobic and hydrophilic character. The nanoparticles can have an aspect ratio ranging from about 1 (e.g., for granular particles) up to about 10,000 (e.g., with similar ratios or ratio ranges as those for EGN particles), with the aspect ratio being generally defined as a long-to-short characteristic length ratio for a given shape (e.g., length-to-diameter for prolate nanoparticles, width-to-thickness for oblate nanoparticles). In the liquid-liquid interfacial technique, the most energetically favorable attachment of particles at the liquid-liquid interface is with a flat or oblate-shaped structure. For flat-shaped particles, larger aspect ratios result in an increased tendency of the nanosheets to attach individually at the liquid-liquid interface.

The substrates suitable for the disclosed film-formation methods are not particularly limited and can include any of a variety of materials. Suitable substrate materials can include glass (e.g., plasma-etched, sodalime, borosilicate, fused silica), silicon (e.g., in electronics applications with the formation of conductive lines on a silicon wafer substrate), polymer, cellulosic materials, and metal (e.g., (stainless) steel, nickel, copper, aluminum). The substrate can be flexible (e.g., a polymer film, metal foil) or rigid, depending on the intended application. The substrate can be pre-coated with a polyelectrolyte or other adhesion-promoting material (e.g., an adhesive or coupling agent) prior to nanoparticle film application, for example in the bulk suspension film formation process. In other embodiments, the film is applied directly to the substrate without an adhesion promoter, for example in the liquid-liquid interfacial film formation process, and the substrate/film may be annealed to promote adhesion between the two materials. Additionally, the substrate may commonly have a planar/flat shape, but suitably can include other arbitrarily shaped substrates (e.g., an irregularly shaped substrate drawn through the liquid used to form a flexible nanoparticle film, thereby applying and conforming the film to the substrate's outer surface).

### Bulk Suspension Film Formation Process

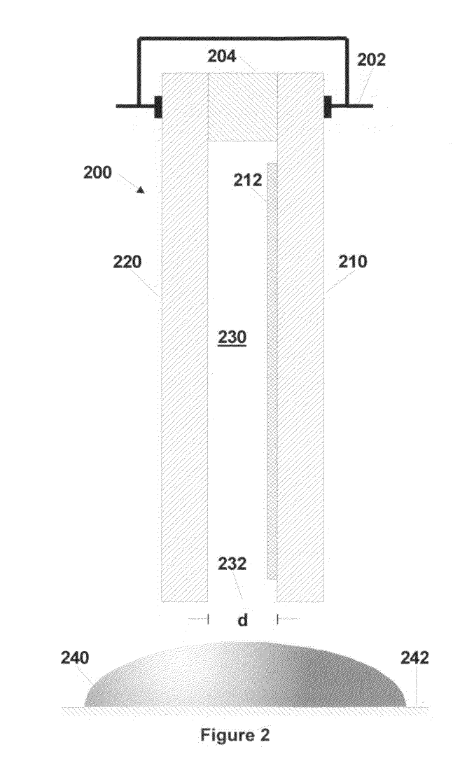

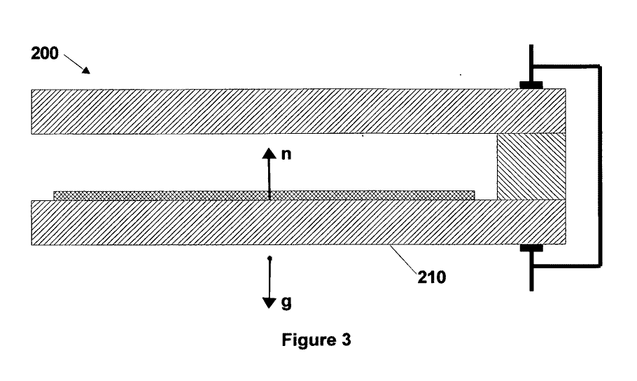

An apparatus for the bulk suspension film formation process is illustrated in FIGS. 2 and 3. The process includes first providing a substrate assembly 200 having a first substrate 210 and a second substrate 220 at a preselected distance d from the first substrate. As illustrated, the first and second substrates 210, 220 are spaced apart using a spacer 204 and held together with a clamp 202. The first and second substrates 210, 220 define an interstitial space 230 between two substrates. The first substrate 210 also includes a first polyelectrolyte 212 deposited on one of its surfaces facing the interstitial space 230. The process also uses a deposition dispersion that includes a liquid medium, a second polyelectrolyte complementary to the first polyelectrolyte (e.g., a pair of polyelectrolytes, one of which is positively charged and one of which is negatively charged), and nanoparticles dispersed therein. The process begins by filling the interstitial space 230 with the deposition dispersion and then evaporating the liquid medium in the interstitial space 230. In an embodiment, an opening 232 of the assembly 200 is contacted with a droplet 240 of the deposition dispersion (e.g., on a surface 242) and the deposition dispersion is drawn into the interstitial space 230 by capillary action. Preferably, as shown in FIG. 3, prior to evaporating the liquid medium, the substrate assembly 200 is oriented so that a normal vector n from the surface of the first substrate 210 is substantially aligned with but opposite in direction to gravity g. As a result, the nanoparticles are deposited as a film on the surface of the first substrate 210 having the first polyelectrolyte 212, thus forming a nanoparticle film-coated substrate (e.g., as illustrated in FIG. 1). Additionally, although FIG. 2 illustrates an embodiment including two substrates, the process can be generalized such that the substrate assembly includes an array of a plurality of substrates in which each substrate has the first polyelectrolyte on at least one of its surfaces so that each interstitial space defined by a pair of adjacent substrates is bounded by at least one surface having the first polyelectrolyte deposited thereon.

The complementary first and second polyelectrolytes are not particularly limited and can include any polymers having repeating units bearing an electrolyte group. The electrolyte groups form ions in aqueous solutions to form polymers (e.g., by dissociation of a salt anion/cation, release of an acidic hydrogen, acquisition of an acidic hydrogen for example by an amino group) having charged groups along their repeating units. The charged groups are complementary in that one polyelectrolyte forms a polyanion in an aqueous solution, while the other forms a polycation in solution, thus allowing the first and second polyelectrolytes to form ionic links between the two polymers. In an embodiment, the polyelectrolyte in the deposition dispersion is coated on the nanoparticles prior to application on the substrate. For example, the nanoparticles can be coated with the polyelectrolye prior to making the deposition dispersion; alternatively, the polyelectrolyte-coated nanoparticles can be formed in the deposition dispersion by mixing/sonicating. The polyelectrolyte in the deposition dispersion preferably has a functional group that promotes the compatibility of the polyelectrolyte with the particular type of nanoparticle in an aqueous solution, for example a polyelectrolyte having an aromatic moiety to promote the compatibility with the basal plane of exfoliated graphite nanoparticles. Suitable polyelectrolytes that form polyanions in solution include poly(styrene sulfonate) (SPS; e.g., including alkali metal salts thereof, for example a sodium salt) and poly(acrylic acid) (PAA; e.g., including the acid and/or alkali metal salts thereof, for example a sodium salt). Suitable polyelectrolytes that form polycations in solution include linear poly(ethylene imine) (LPEI), poly(diallyldimethyl ammonium chloride) (PDAC; also including other salts or halogen salts thereof), and poly(allylamine hydrochloride) (PAH; also including other salts or halogen salts thereof). Suitably, EGN particles can be sonicated in presence of about 0.1 M SPS suspension in a 0.1 M NaCl aqueous solution. Sonicating the mixture breaks the EGN agglomerates to create a favorable interaction between the aromatic moiety of SPS and graphite basal plane. It appears that once the SPS are attached to the EGN basal plane, it is the electrostatic repulsion between the ionic tails of SPS that stabilizes the dispersion of hydrophobic EGN in water.

### Liquid-Liquid Interfacial Film Formation Process

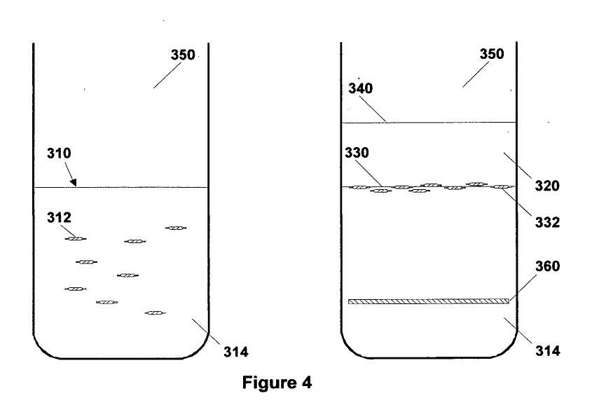

A liquid-liquid interfacial film formation process is illustrated in FIG. 4. The process includes first providing a suspension formulation 310 that includes a hydrophobic liquid medium 314 and EGN platelets 312 dispersed therein. An immiscible, hydrophilic liquid 320 is then mixed with the suspension formulation (e.g., by sonicating the hydrophilic liquid and the suspension formulation, thereby forming an emulsion between the hydrophobic liquid and the hydrophilic liquid). The EGN platelets 312 are then concentrated as a monolayer 332 at a liquid-liquid interface 330 between the hydrophobic liquid and the hydrophilic liquid (e.g., by allowing the emulsion to separate, thereby forming separate hydrophobic liquid and hydrophilic liquid phases and accumulating the EGN platelets at the liquid-liquid interface). The EGN platelet monolayer 332 is then deposited as a film on a substrate 360, thereby forming an EGN film-coated substrate 100. The EGN platelet monolayer 332 can be deposited on the substrate 360 by dipping the substrate 360 into the hydrophobic/hydrophilic liquids (e.g., by pulling the substrate 360 from beneath the liquid-liquid interface 330 through the monolayer 332 as shown in FIG. 4, with the possibility of first decanting all or a portion of the hydrophilic liquid 320). In an embodiment, deposition can be performed by transferring at least a portion of the EGN platelet monolayer 332 and the hydrophobic liquid 314 from the liquid-liquid interface 330 to a gas-liquid interface 340 between the hydrophilic liquid 320 and a gaseous external environment 350 (e.g., ambient air); evaporating the hydrophobic liquid 314 at the gas-liquid interface 340, leaving the EGN platelet monolayer 332 at the gas-liquid interface 340; and then pulling the substrate 360 through the hydrophilic liquid 320 to the gaseous external environment 350, thereby depositing the EGN platelet monolayer 332 on the substrate 360 as the substrate 360 passes through the gas-liquid interface 340.

In an embodiment, the liquid-liquid interfacial film formation process can be extended to the formation of multilayer EGN films and/or free-standing EGN films (i.e., not coated or otherwise bound to a substrate). For example, the EGN film-coated substrate from the foregoing process (i.e., a monolayer film coated on a substrate) can be annealed (e.g., at about 250° C.) to ensure that the EGN film adheres to the substrate. The foregoing steps for forming a monolayer EGN film at a liquid-liquid interface are repeated (i.e., providing a suspension formulation, mixing it with an immiscible, hydrophilic liquid, and then concentrating the monolayer of EGN platelets at the liquid-liquid interface). The interfacial EGN platelet monolayer is then deposited as a film on the previously annealed, EGN film-coated substrate, thereby forming a multilayer EGN film-coated substrate. The repetitive process can be serially performed any number of times to create a multilayer structure having any desired number of sequentially deposited EGN monolayers. While the final multilayer EGN film-coated substrate can be used in the coated form, a free-standing multilayer EGN film also can be formed by immersing the multilayer EGN film-coated substrate in the hydrophilic liquid until the multilayer EGN film separates from the substrate.

In the liquid-liquid interfacial film formation process, the two liquid media (e.g., hydrophobic liquid medium 314 and hydrophilic liquid medium 320 described above) generally can include any two immiscible liquids that form a stable interfacial boundary upon vigorous mixing (e.g., sonication, mechanical mixing/shaking/stirring etc.). The hydrophobic liquid supports the stable dispersion of hydrophobic nanoparticles therein, for example prior to mixing with an immiscible hydrophilic liquid. The specific hydrophobic liquid is not particularly limited, with chlorinated organic solvents (e.g., chloroform, methylene chloride) being suitable in addition to other organic solvents in general (e.g., alkanes). Similarly, the specific hydrophilic liquid is not particularly limited, with water being suitable based on functional, cost, and safety considerations. In general, any hydrophobic liquid generating a positive interfacial tension in presence of the hydrophilic liquid is suitable for the adsorption of EGN at the liquid-liquid interface; however, the hydrophobic liquid suitably promotes an even dispersion of the EGN prior to mixture with the hydrophilic liquid and adsorption at the liquid-liquid interface. In an embodiment (e.g., in a chloroform-water system), the hydrophobic liquid is denser than the hydrophilic liquid and will form the bottom phase when the two are mixed in the liquid-liquid interfacial film formation process. However, the process can be performed with a liquid-liquid system in which the hydrophilic liquid is denser than the hydrophobic liquid, resulting in the hydrophilic liquid being the bottom phase in the liquid-liquid system.

Additional description related to the present disclosure, which is herein incorporated by reference in its entirety, includes U.S. Patent Application Publication Nos. 2006/0231792 and 2006/0241237 (Drzal et al.) and relates to methods and apparatus for forming expanded graphite nanoparticles using microwaves or radiofrequency waves. Additional disclosure related to exfoliated graphite nanoparticles may be found in U.S. Patent Application Publication Nos. 2004/0127621 and 2008/0206124.

### Examples

The following Examples illustrate the disclosed compositions and methods, but are not intended to limit the scope of any claims thereto.

### Example 1

### Bulk Suspension Film Formation (Convective Assembly)

An EGN film-coated glass slide was formed according to the following bulk suspension film formation process (i.e., convective assembly). The EGN platelets can range from about 0.3 nm to 10 nm in thickness.

(1) When a drop of a colloidal suspension of particles is placed on a hydrophilic substrate like glass, water evaporates rapidly from the edge of the droplet. This rapid evaporation of water from the edge of the droplet creates a pressure difference between particles at the droplet edge and the balancing hydrostatic pressure from the bulk solution. This pressure gradient generates transport of water and particles from the bulk suspension to the edge of the droplet. As water continues to evaporate, the particles form an ordered array resulting in a highly compact monolayer and multilayer structure. This basic principle is the basis for this new fabrication technique to produce highly compact monolayer and multilayer structures of particles such as EGN on a glass substrate.

(2) A stable dispersion of EGN in water is used in the convective self assembly process. However, EGN is highly hydrophobic, and a negatively charged polyelectrolyte sodium polystyrene sulfonate (SPS) is used to produce a stable dispersion in water. While the aromatic moiety of SPS helps to interact with the EGN basal plane, the presence of a hydrophilic sulfonate tail keeps it well dispersed in water. Thus, EGN is coated with the negatively charged SPS polyelectrolyte. To coat the negatively charged SPS coated EGN on a hydrophilic surface like glass, a positively charged polyelectrolyte poly(diallyldimethyl ammonium chloride) (PDAC) is first coated on oxygen plasma etched glass surface. The interaction between two oppositely charged polyelectrolytes makes it possible to deposit EGN on the glass surface. However, the challenge is in the formation of a highly compact monolayer and multilayer structure of EGN on the glass surface.

(3) When a single glass slide is vertically immersed in a water suspension of EGN (e.g., according to the LBL method of deposition), the particles are deposited on the surface at the meniscus edge as the plate is withdrawn due to the continuous evaporation of water from the edge of the meniscus. This convective self assembly process results in dense packing of EGN on the surface of the glass slide. However, such a process does not allow control of the number of layers of particles and multiple concurrent depositions of the particles on top of one another can result. In contrast, the present process permits the controlled deposition of EGN on the glass surface (e.g., in terms of the thickness of the deposited film).

(4) An assembly of two glass slides is made consisting of one coated with positively charged polyelectrolyte such as PDAC and the other one without any chemical treatment. The two glass slides are fixed together with a clamp and the space between them is controlled buy inserting a 150 μm glass cover slip between them at the ends of the assembly. When few drops of the SPS coated EGN suspension in water are placed in contact with the bottom of these two glass slides, the strong capillary force sucks the suspension into the 150 μm gap and fills the entire space completely. The 150 μm separation generates sufficient capillary force to hold the liquid inside. The slides are then placed inside a desiccator with the positively charged PDAC coated glass slide at the bottom, allowing the water to slowly evaporate naturally.

(5) After the complete evaporation of the water, which is very quick, the glass slides are separated and the EGN coated glass is thoroughly washed with water and dried at 100° C. It was found that negatively charged SPS coated EGN deposited only on the bottom glass slide coated with positively charged PDAC, and not on the other glass slide.

(6) It was found that the concentration of EGN in the water suspension is an important factor to control the creation of a compact monolayer or multilayer structure. At a EGN concentration of 0.1 wt %, convective evaporation resulted in self assembly EGN in compact monolayer structure in most areas of the film. However, with increasing concentration of EGN, the formation of bilayers and multilayer was clearly evident. With reduced concentration, the self assembly resulted in an island like discontinuous structure.

(7) The resulting EGN film showed high electrical conductivity with very high transparency. The electrical conductivity of the EGN film prepared by this single step method is comparable to the conductivity attainable with ten layer deposition of EGN by the well known LBL method. However, the transparency of this film is several times that of the EGN film formed by the LBL method.

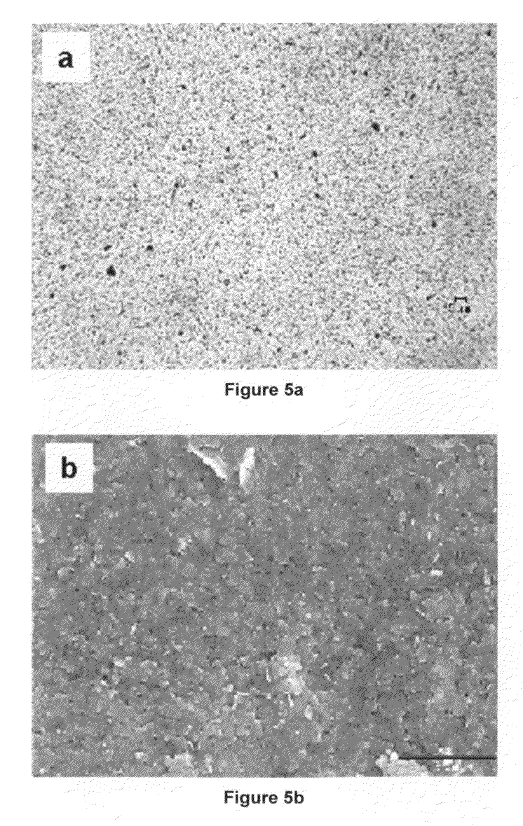

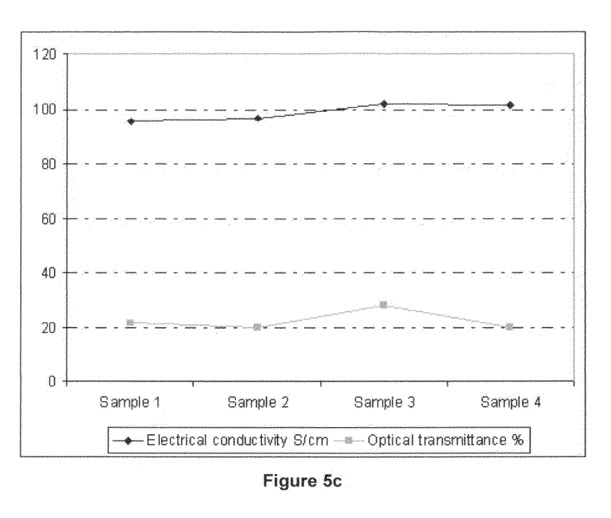

Film Optical and Electrical Properties: The film's optical transparency was measured using UV-VIS spectroscopy. The average transparency was about 25% at the 500 nm wavelength of the visible spectrum. The morphology of the film was characterized by optical microscopy and scanning electron microscopy images. FIGS. 5a and 5b show the highly compact film of graphene nanoplatelets deposited on the glass slide by convective assembly technique. The film's electrical conductivity was measured by a two-point probe method. The maximum film conductivity was measured as 101.5 S/cm with an optical transparency of about 25% (FIG. 5c). The electrical conductivity could be improved at the expense of optical transparency with increasing thickness of the film or from transition from the monolayer to multilayer film. However, with a reduced thickness of the nanoplatelets and with a better dispersion in water, an improved electrical conductivity and optical transparency can be achieved.

The average thickness of EGN is 5 nm. However, agglomeration and restacking nature of graphene results in much thicker nanosheets in water even in the presence of polyelectrolyte like SPS. Stable suspensions of EGN platelets without agglomeration and restacking are desirable. Since the thickness of the nanosheet is the factor controlling the optical transparency of the resulting film, the method is being investigated using thinner graphene sheets. Using this single step method, with reduced thickness and better dispersion of EGN, the transparency is expected to reach more than 80% with electrical conductivity of more than 100 S/cm.

This technique is ubiquitous in that it can be used with any nanoparticles such as metals, metal oxides, or carbon nanotubes. While compact monolayer films of carbon nanotubes have potential in optoelectronics or FET applications, a compact monolayer film of metal or metal oxide nanoparticles have potential applications in electric, magnetic, ion exchange, catalytic and photocatalytic areas.

### Example 2

### Liquid-Liquid Interfacial Film Formation (Coated Substrate)

An EGN film-coated glass slide was formed according to the following liquid-liquid interfacial film formation process.

(1) In one embodiment, the method produces a monolayer of EGN floating on water at an air-water interface through which the solid surface to be coated is withdrawn, thereby transferring the EGN monolayer of particles as a coating on the substrate surface. This uses EGN molecules that are first dispersed in a solvent, which is selected for its immiscibility with water. A few drops of this suspension are placed on the top of the water surface. The balance between the surface tension, interfacial tension, spreading tension and capillary force makes it possible for the particles to assemble in a close packed monolayer structure at the air water interface.

(2) EGN is highly hydrophobic in nature and it is very difficult to disperse this material in common polar solvent. Chloroform and dichloromethane are preferred solvents providing a stable dispersion of EGN.

(3) A very little amount of EGN is first dispersed in chloroform using high power sonication for a very short duration of time. The concentration of EGN is generally low (e.g., 5×10⁻⁴ wt. %).

(4) Water is then added to the dispersion and high shear is applied in the form of ultra-sonication to form a milky emulsion between the two immiscible phases of water and chloroform. A distinct interface forms between the water saturated chloroform and the chloroform saturated water phases. The well dispersed and disc-shaped EGN platelets are confined at the interface between the chloroform and water phases.

(5) A small amount of the EGN from the interface is then transferred to the surface of water. The water saturated chloroform spreads rapidly forming a monolayer of EGN. Evaporation of the highly volatile chloroform finally results in a monolayer film of EGN at the air-water interface.

(6) Next, the solid substrate is pulled through the EGN monolayer from below the surface, resulting in an assembled monolayer.

(7) This monolayer film of EGN on the substrate is then heated at 150° C. to remove the residual water and/or chloroform completely.

(8) The resultant film shows transparency of around 55% in the electromagnetic spectrum of visible region. In the infrared region, it shows no absorption and a transparency of around 70%.

(9) The electrical conductivity of the film is measured by two point probe method and it is around 100 S/cm.

The film's optical transparency was measured using UV-VIS spectroscopy. With low surface area materials (i.e., about 45 layers thick or about 15 nm thick), the transparency of the film is as low as 10%. With increasing surface area, the thickness of the nanosheet decreases, and the transparency of the corresponding film increases. The average thickness of the EGN is about 5 nm to 6 nm. However, thinner sheets of EGN with a thickness of about 0.3 nm can be used to increase optical transparency, for example to at least about 90%.

### Example 3

### Liquid-Liquid Interfacial Film Formation (Free-Standing Film or Coated Substrate)

Both a free-standing EGN film and an EGN film-coated substrate (mono- or multilayer film) can be formed according to the following liquid-liquid interfacial film formation process. The EGN film-coated substrate can be formed as indicated in steps (6) and (7) below (e.g., by omitting subsequent step (9) to release the film from the substrate by immersion in water or other solvent). Steps (1) to (9) describe the method in general and are followed by a description of a more specific example of the process.

(1) Exfoliated graphite nanoplatelets are first dispersed in a chlorinated solvent such as chloroform. The dispersion is quite stable without any visible deposition for more than 48 hours. Such stable dispersion keeps the platelets separate from each other. (Other similar solvents can be used in place of chloroform.)

(2) When water is added to the dispersion of graphene nanoplatelets in chloroform, the solution separates into two distinct phases of the immiscible liquids water and chloroform.

(3) The mixture is then briefly sonicated to create a large interfacial area between the two immiscible liquids. Under these conditions, driven by the minimization of the interfacial free energy, the nanoplatelets are preferentially adsorbed at the water-chloroform interface.

(4) The gain in the interfacial free energy makes it possible to create a highly compact monolayer of these platelets without any possible agglomeration or restacking.

(5) Using a simple dipping technique, a monolayer film of the graphene nanoplatelets can be deposited on any desired substrate from the liquid-liquid interface. This monolayer film of graphene nanoplatelets can also be transferred from the liquid-liquid interface to the air-water interface to deposit it on the desired substrate.

(6) Once a monolayer film is transferred on a substrate (e.g., glass), it is annealed (e.g., at 250° C.) to form a film that adheres to the glass surface. With this monolayer coating of graphene nanoplatelets, the highly hydrophilic glass surface becomes hydrophobic.

(7) This monolayer film of graphene nanoplatelets from the liquid-liquid interface can be made thicker by repeating this process sequentially to create a multilayer structure. When one monolayer film of graphene nanoplatelets is transferred from the interface on top of another graphene nanoplatelets film and heated, the removal of the trapped solvent film between two layers creates a large capillary force to pull two adjacent layers close together. After complete removal of solvent, a multilayer film is obtained.

(8) Since this multilayer structure of graphene nanoplatelets is formed from the continual deposition of compact monolayer film of graphene nanoplatelets, the platelets are always highly aligned inside the multilayer film with the platelets lying flat, one on top of another. Such orientation of the platelets inside the film generates high van der Waals attraction forces between nanoplatelets to create a multilayer structure.

(9) The multilayer film on the glass substrate is then immersed in water. While immersed in water, the highly hydrophobic multilayer film of graphene nanoplatelets can be separated from the hydrophilic glass surface and floats on the water surface. The film is then dried at 100° C. to finalize the multilayer free-standing film. The storage modulus of the film is close to 4 GPa, and the electrical conductivity is more than 1000 S/cm. The thermal conductivity of this film is also several hundred W/m-K.

(10) The film thickness can be easily controlled from nanoscale to micro or macroscale by depositing desired number of monolayers.

(11) Monolayer films of metal or metal oxide nanoparticles can be easily produced on top of a water surface by a Langmuir Blodgett technique. This monolayer film of metal or metal oxide nanoparticles can be easily transferred to the top of a graphene nanoplatelet film (monolayer or multilayer) to produce a composite film (e.g., multilayer EGN-metal or EGN-metal oxide).

The multilayer free standing film of graphene nanoplatelets can be used as an electrode material for supercapacitors, lithium ion batteries, and fuel cell applications. Presently, nanoplatelets with a thickness of about 4 to 6 nm are used. However, even thinner nanoplatelets down to about 0.3 nm can be utilized to prepare free-standing films assembled from a variable number of monolayers of single graphene sheets. Such free-standing films should be transparent, highly electrically conductive, and highly thermally conductive. This multilayered nanostructured graphene nanoplatelet transparent free-standing film has tremendous potential in organic photovoltaic cell applications, supercapacitors, lithium ion batteries, hydrogen storage devices, fuel cells, thermoelectric materials, etc. The addition of metal nanoparticles to the surfaces of the individual layers and incorporating them in the free standing multilayer film for energy storage and catalysis applications is also possible.

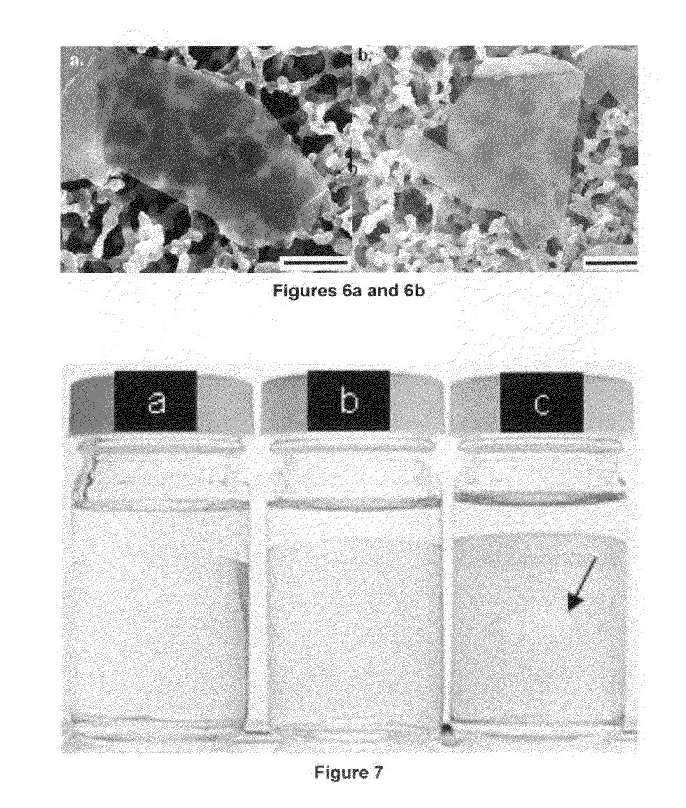

Graphene nanosheets were first sonicated in chloroform at a concentration of 0.1 mg/mL. The dispersion was centrifuged for 10 min at 5000 rpm to separate the thinner nanosheets from the semi transparent supernatant liquid at the top. FIG. 6a, b shows the field emission scanning electron microscopy (FESEM) image of a typical graphene nanosheet deposited on a cellulose acetate filter membrane from the centrifugally separated chloroform dispersion. The average size of the nanosheet is estimated to be 8 to 10 μm. The average thickness of the starting graphene nanosheets was previously estimated to be less than 10 nm. However, after the separation of the thinner nanosheets by centrifuging, AFM was used to measure the thickness of individual nanosheets, which were found to have an average nanosheet thickness ranging from about 3 to 4 nm. However, it should be noted that nanosheets are not completely lying flat on the substrate and, thus, there are some variations in the height.

FIG. 7 illustrates various steps to produce the two dimensional arrays of graphene nanosheets at the liquid-liquid interface. The first nanosheets are dispersed in chloroform, and after water is added to the mixture two distinct phases formed containing graphene nanosheets dispersed in the chloroform phase. However, to transport the nanosheets completely from the bulk phase to the liquid-liquid interface requires an input of mechanical work through sonication for a brief period of time. The external mechanical force breaks the two immiscible liquid phases into numerous drops and bubbles creating a large interfacial area between the two liquids. Driven by the minimization of interfacial free energy, the graphene nanosheets are preferentially adsorbed at the chloroform-water interface.

Interfacial adsorption of particles at the interface reduces the entropy by the Boltzmann factor. Therefore the gain in the interfacial energy is responsible for the stability of the particles at the interface. The three interfacial energies at the particle-oil interface γₚₒ, particle-water interface γ_{pw}, and oil-water interface γ_{ow} are related to each other through the three phase contact angle by the Young's equation as:

cos θ=(γₚₒ−γ_{pw})/γ_{ow}

Apart from the three interfacial energies, the role of particle size and shape are paramount to the gain in the total interfacial energy of the system. Following an analysis, developed by Binks, the energy of attachment of the disk- or flat-shaped particle over various contact angles at the liquid-liquid interface can be analyzed. In contrast to spherical nanoparticles, a disk- or plate-shaped particle, such as this graphene nanosheet is characterized by two different axes. The longer axis is along the width of the nanosheet and the aspect ratio “a/b” is thus the ratio of two axes along the width and thickness of the nanosheets. With the thickness and average width of the nanosheets taken as 4 nm and 10 μm, respectively, the aspect ratio a/b is 2500. Assuming that particles are attached to a planar oil-water interface, the free energy of detachment of a planar nanosheet into the water and the chloroform phase is given as:

ΔG_{dw}=γ_{ow}πb²(1−cos θ)²[1+(a/b−1)²/(1−cos θ)+2(a/b−1)(sin θ−cos θ)/(1−cos θ)²] (i)

and

ΔG_{chl}=ΔG_{dw}+2 πγ_{ow}b²cos θ[(a/b−1)²π(a/b−1)+2] (ii)

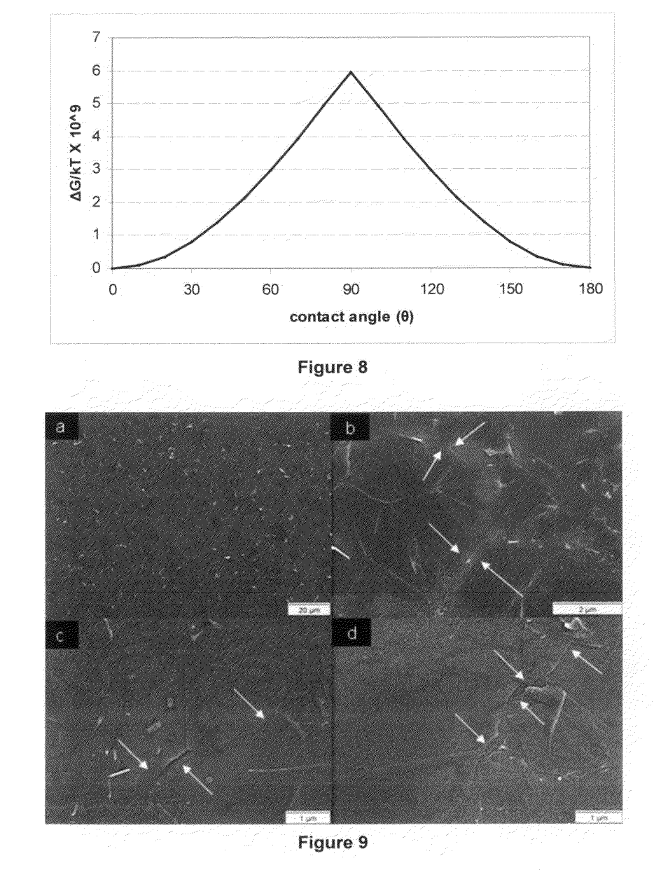

In the above, ΔG_{dw} and ΔG_{chl} are the free energies of detachment of the particle from the interface into the water and the chloroform phase respectively. “γ_{ow}” is the interfacial energy at the chloroform water interface. Equation (i) describes the free energy of detachment of the particle into the water phase at contact angle between 0 to 90° and equation (ii) corresponds to the free energy of detachment of the particle into the chloroform phase at contact angle between 90 to 180°. The free energy of particle detachment as compared to the thermal energy at various contact angle θ is shown in FIG. 8.

At equilibrium, free energy of attachment of the particle to the liquid-liquid interface is ΔGₐ=−ΔG_{d}. With the measured three phase contact angle between water and chloroform on the graphene nanosheet close to 94°, the above calculation predicts that the particle attachment at the liquid-liquid interface is energetically highly favorable. Therefore, the larger and thinner the nanosheet, the higher would be the aspect ratio, and it is more favorable for the nanosheets to get adsorbed at the interface with substantial gain in the interfacial energy.

In natural graphite, the layers of graphene are strongly attached to each other by van der Waals force of attraction. The cohesive energy is 5.8 kJ/mol with each layer being separated by a distance of 3.36 Å. After intercalation and exfoliation, these layers are separated from each other. However, the attractive interaction energy between the graphene nanosheets is strong. In this example, the thinner nanosheets of graphene, separated by centrifugation in chloroform, is very stable for days without any visible settling keeping the individual nanosheets separated from each other. Introduction of the water phase and subsequent sonication produces a large interfacial area between these two immiscible liquids. At this point, the nanosheets gain interfacial free energy by adsorption at the liquid-liquid interface rather than restacking and settling out of the suspension. Thus with increasing concentration, nanosheets are expected to concentrate at the liquid-liquid interface. Experimentally, it was found that with increasing nanosheet concentration the extent of the interfacial adsorption area covered with the nanosheets increased. The graphene nanosheet film extended downward toward the edge of the chloroform phase with a thin layer of water outside (FIG. 7, panel c). However, at higher concentration, thick layers of nanosheets were found near the interface resulting in agglomeration and coalescence. Thus, while the gain in interfacial energy drives nanosheets to form a monolayer at the liquid-liquid interface, the concentration of the nanosheets must be controlled to prevent nanosheet agglomeration and coalescence.

The thin graphene nanosheet film formed at this liquid-liquid interface was transferred onto a glass substrate and the morphology and orientation of the graphene nanosheets were characterized by the high resolution FESEM imaging. Representative images taken from different sections of the film are shown in FIG. 9. From the FESEM characterization, it is evident that the graphene nanosheets form a close packed array with remarkable uniformity over a macroscopic sized area. The graphene nanosheets are well dispersed and interconnected at the edges with little detectable gaps. Furthermore, there was very little overlapping of the graphene nanosheets observed.

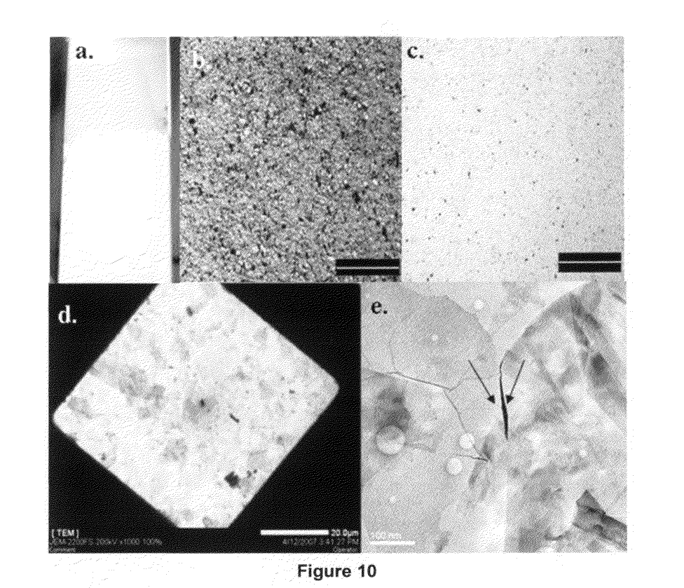

The metallic luster of the graphene nanosheet film, as shown in FIG. 10a, indicates a close-packed structure over large macroscopic area. The formation of compact monolayer structure was further evident from the optical microscopy image of films prepared from two different nanosheet thicknesses. The darker regions in the optical micrograph of FIG. 10b represent film prepared from nanosheets with an average thickness of 10 nm. Under similar measurement condition, films prepared from nanosheets with an average thickness of 3 to 4 nm show high transparency over a large macroscopic area as shown in FIG. 10c. A complete overlap between thinner nanosheets in FIG. 10c would have resulted in reduced transparency as shown in FIG. 10b. This result substantiates the fact that individual adsorption of the nanosheets at the liquid-liquid interface is energetically more favorable than restacking and agglomerating with each other. Low- and high-magnification transmission electron microscopy (TEM) images in FIGS. 10d, e also reveal a compact monolayer structure with two individual nanosheets touching each others at the edges as shown in FIG. 10e.

Thus the above investigations from FESEM, TEM, and optical microscopy suggests that once the minimization of interfacial energy drives the nanosheets from the bulk phase to the liquid-liquid interface, they self-assemble as a result of force of interaction between them to create a large-area, close-packed monolayer structure.

These graphene nanosheets are highly hydrophobic. However, a very small amount of oxygen functional groups always covers the edge of the nanosheet. The presence of both hydrophobic and hydrophilic faces at the edge of the nanosheet can perturb the interface large enough to generate a menisci around the particle. Attractive lateral capillary force generates from the overlap of such “like” menisci around the particle to form a close-packed structure at the liquid-liquid interface. The magnitude of this lateral capillary force is negligible for spherical particles with diameter less than 10 μm. For planar-shaped particles at the liquid-liquid interface, however, the lateral capillary force is quite significant even for particles with thicknesses of few nanometers. As two planar-shaped bodies approach each other, the height of the meniscus is related to the change in the arc length. The interfacial energy is then obtained by multiplying the change in arc length, the interfacial tension between two liquids and the aspect ratio of the nanosheet. Following this same approach, calculation of the interfacial free energy shows that the capillary force driven two-dimensional self-assembly of graphene nanosheets is energetically favorable with a ΔG of more than −10 k_{B}T at nanosheet thickness of 4 nm with an aspect ratio of 2500. As a result this capillary force drives the graphene nanosheets to each other maximizing their hydrophobic surface area and creating a close packed monolayer at the liquid-liquid interface in exact agreement with our observation and measurement.

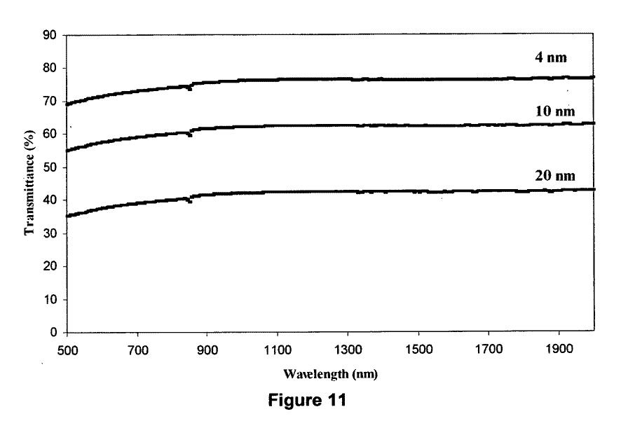

Graphene nanosheet film transparency was measured at various film thicknesses. The thickness of the nanosheet depends on the surface area of the parent exfoliated graphene nanosheet. Thin sheets of graphene were separated from exfoliated graphene nanosheet with different surface areas. With low surface area materials, the transparency of the film is as low as 10%. With increasing surface area, the thickness of the nanosheet decreases and the transparency of the corresponding film increases. FIG. 11 represents the optical transmission profile of graphene nanosheet film obtained from different thickness nanosheets. At a visible wavelength of 500 nm, the transmission of graphene nanosheet film having an average thickness of 4 nm is about 70%. The transmission increases to slightly less than 80% at increasing wavelength (e.g., up to about 2000 nm, in the infrared spectrum). A single layer of graphene has an absorption of incident white light of about 2.3%, which correlates to the measured values for a nanosheet thickness of 3 to 4 nm in this example (e.g., a transmission ranging from about 70% to about 80% at various wavelengths).

The electrical conductivity of the graphene nanosheet film was measured by using the four point probe method at 10 different locations on the film. The average sheet resistance of the graphene nanosheet film of 4 nm thickness is 102 Ω/sq and the average conductivity is more than 1000 S/cm. The highest electrical conductivity was near 1250 S/cm. This high value of electrical conductivity is comparable with FTO-coated glass slides as well as transparent carbon nanotube electrodes. However, compared to the conventional metal oxides like ITO or FTO, this monolayer film is thermally very stable. After heating a specimen at 350° C. for more than 3 h in an ambient atmosphere, the conductivity of the film did not change. In contrast to graphene nanosheet films made from reduced graphite oxide, the electrical conductivity of this graphene nanosheet film is independent of the film thickness. The average film conductivity was found to be more than 1000 S/cm, regardless of film thicknesses. This observation is consistent with the fact that these nanosheets form a close-packed monolayer at the liquid-liquid interface. This close-packed structure ensures high electrical conductivity irrespective of the thickness of the nanosheet.

Ultrathin layers of graphene produced using the graphite oxide route allows water-based processing but requires the use of hazardous chemicals to produce graphite oxide and to reduce it back to graphene. In contrast, this example illustrates that the highly hydrophobic nature of the graphene nanosheet can be used to self-assemble a thin graphene nanosheet at the hydrophobic liquid-hydrophilic liquid interface into a close packed monolayer. As a result, the native properties of graphene are preserved without requiring chemical transformation of the basal plane. The resulting graphene nanosheet monolayer film is highly compact, optically transparent from the visible to the infrared region and electrically conductive. The large microscopic size of the graphene nanosheets that comprise the film reduces the contact resistance over the macroscopic area of the film. The graphene nanosheets are inexpensive to produce and the process to form a monolayer is easily scalable to very large areas offering a new material and method to replace ITO and FTO coatings for optoelectronics applications.

### Example 4

### Liquid-Liquid Interfacial Film Formation (Free-Standing Multilayer Film)

The general liquid-liquid interfacial film-formation technique described herein can be used to form cohesive multilayer films (e.g., from exfoliated graphite nanoparticles) without the use of binders (e.g., polymeric or otherwise). The following example describes a process for the formation of multilayer films ranging in thickness from about 5 μm to about 100 μm.

In the liquid-liquid interfacial adsorption technique, nanosheets of average lateral dimension of 15 μm and thickness of 3 to 5 nm were first dispersed in chloroform (e.g., by sonication for 90 sec) followed by the addition of a small amount of water to create a two phase mixture. This two phase mixture was then briefly sonicated (e.g., for 90 sec) to create a large interfacial area between the two immiscible liquids. At this point, the transport of graphene nanosheet from the bulk phase towards the liquid-liquid interface was driven by the minimization of interfacial energy, resulting in the nanosheets being absorbed at the liquid-liquid interface. With continued vigorous shaking, numerous emulsion droplets are formed with the nanosheets at the interface between the two immiscible liquids. When droplets reach the air-water interface, they spread into a thin film and the chloroform evaporates quickly resulting in a dry film of graphene nanosheet floating at the air-water interface. Although the film can be recovered (e.g., applied to a substrate) from the liquid-liquid interface directly, the film can conveniently be transferred to the air-water interface by mechanical means. For example, injection of water from a pipette at the liquid-liquid interface partially disrupts the film at the interface, breaking the film into smaller fragments with an increased buoyancy that can float to the air-water surface. In any event, the interfacial self assembly approach had the advantage to create a highly dispersed monolayer network of hydrophobic nanosheets over a large macroscopic area without requiring any chemical transformation of the graphene basal plane. With the retention of this strong aromatic character, layers of these highly dispersed networks of graphene nanosheets were expected to interact strongly with each other in a “face-to-face” union of large basal planes. Van der Waals force induced stacking of these nanosheets is the key to our approach to create a highly aligned, multilayer structure from successive depositions of close packed monolayer films one on top of another.

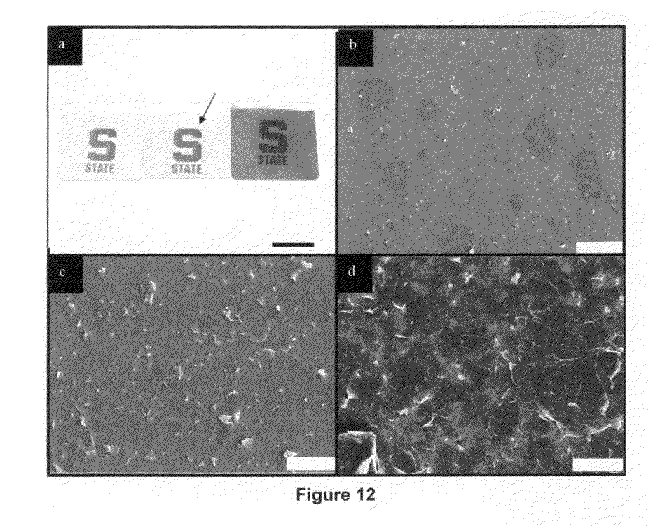

In creating a multilayer structure, first a monolayer film of graphene nanosheets was transferred on a solid substrate such as a microscopic glass slide (FIG. 12a) (e.g., by pulling a glass substrate through the air-water interface). The film was then annealed at 100° C. to completely drive off the liquid. When a second layer of monolayer film was transferred on top of a pre-existing film (mono- or multi-layer), a thin film of water separates the nanosheets, thus preventing close contact with each other. With continuous evaporation of water, the interlayer separation decreases and the strong capillary force causes the nanosheet spacing to decrease and the layers to collapse on each other. On complete liquid evaporation, strong van der Waal's force of attraction adheres these planar nanosheets into a stable bilayer (or multilayer for subsequent steps) structure. The bilayer film was annealed again at 100° C. (FIG. 12a middle slide). A multilayer film is formed by successive depositions of the monolayer films one on top of another.

As compared to spherical points or parallel chain molecules, the van der Waals interaction free energy between two parallel planes is much higher and it scales with the separation distance (d) as (1/d²). Thus when two monolayer films of planar nanosheets are placed one on top of another, a large van der Waals force of attraction causes them to adhere with each other and form a stable bilayer and multilayer structure. It is also possible that the π-electron interaction between the large basal planes also contributes to this interaction.

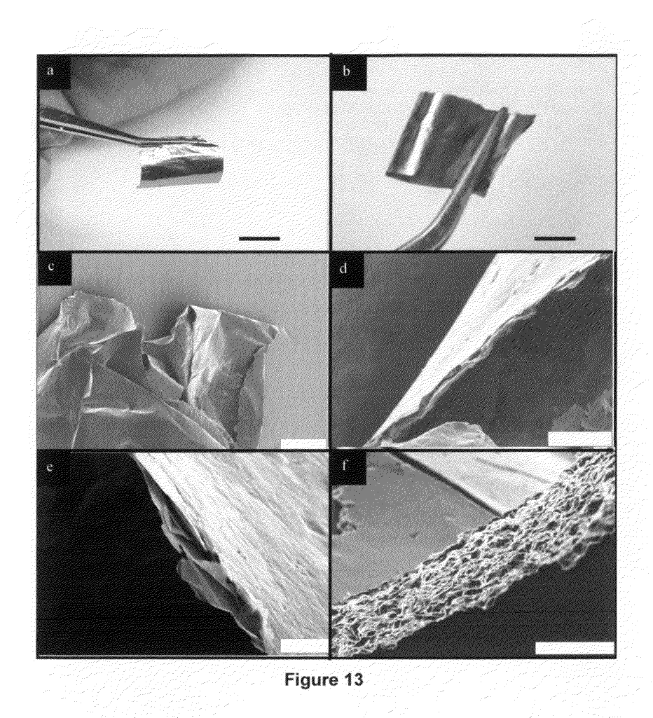

This process of capillary- and drying-induced self-assembly of successive monolayers is continued to build a multilayer film of desired thicknesses. The film can then be detached from the solid substrate by immersing it in water (e.g., at about 50° C. to about 60° C.) which slowly wets the glass surface and causes the displacement of this highly hydrophobic film from the glass surface to a state where it floats on the water surface (e.g., after a few hours and gentle shaking of the substrate in water). The film is then carefully lifted and dried at 100° C. to obtain a free standing, multilayer film of graphene nanosheets as shown in FIG. 13. FESEM micrographs clearly show that the film is flexible without any cracks over the large macroscopic area.

As shown in FIGS. 13d-13f, films of various thicknesses can be prepared by controlling the number of deposited layers. This process results in the formation of a 100% binder-free multilayer, free-standing film of graphene nanosheets that are uniformly dispersed and strongly attached to each other over a large macroscopic area. The graphene nanosheets comprising this film are highly aromatic in character, and the interlayer attraction between the large basal planes is dominated by van der Waal's force rather than the interlayer hydrogen bonding reported for chemically modified graphite oxide basal planes. TGA analysis showed no appreciable weight loss (e.g., less than 4 wt % in air) in the temperature range between 100° C. to 350° C. In contrast, a considerable weight loss is observed in graphite-oxide based systems owing to the release of interlayer water molecules and the decomposition of the surface oxides resulting in a mixture of CO and CO₂ from the various oxygen functionalities present on the graphene basal plane. The highly hydrophobic character of the film was also evident from the large contact angle) (−96.7° formed by a water droplet on the film. With the absence of interlayer hydrogen bonding and the presence of turbostratic stacking of graphene nanosheets in different layers, the film is strong enough to hold together over large macroscopic areas even when completely bent and rolled in a cylindrical shape. The Raman spectra, measured on the multilayer film, exhibits a sharp G-band peak at 1575 cm⁻¹ and a minor D band peak at 1344 cm⁻¹. The aromatic purity of the film is also evident from this low I(D)/I(G) ratio, which is a direct measure of the degree of defects, disorder and structural incoherence of crystalline graphitic domain of the large basal plane on graphene nanosheets. As a result, the ‘as-prepared’ multilayer film exhibits very high electrical conductivity of the order of 2.14×10⁴ S/m, measured by using a four point probe set up on an average of three samples.

Instruments and Measurements: TGA analysis was carried out at 5° C./min in air by Hi-Res Thermogravimatric Analyzer from TA instrument. A Perkin Elmer Phi 5400 ESCA system with a magnesium Kα X-ray source was used for XPS measurements. Samples were analyzed at pressures between 10⁻⁹ and 10⁻⁸ torr with a pass energy of 29.35 eV and a take-off angle of 45°. The spot size is roughly 250 μm². Contact angles were measured on a KRUSS drop shape analysis system DSA 10 Mk2. FESEM images were taken by JEOL JSM-7500F scanning electron microscope.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

Throughout the specification, where the compositions, processes, or apparatus are described as including components, steps, or materials, it is contemplated that the compositions, processes, or apparatus can also comprise, consist essentially of, or consist of, any combination of the recited components or materials, unless described otherwise. Numerical values and ranges can represent the value/range as stated (e.g., unmodified by the term “about”) or an approximate value/range (e.g., modified by the term “about”). Combinations of components are contemplated to include homogeneous and/or heterogeneous mixtures, as would be understood by a person of ordinary skill in the art in view of the foregoing disclosure.

What is claimed is:

1. An exfoliated graphite nanoparticle (EGN) film comprising:
(a) a monolayer EGN film comprising (i) exfoliated graphite nanoparticles and (ii) a first polyelectrolyte distributed throughout the monolayer EGN film, or (b) a multilayer EGN film comprising a plurality of the monolayer EGN films arranged in a layered configuration;
wherein:
(i) the monolayer EGN film has a thickness ranging from about 0.2 nm to about 20 nm;
(ii) the monolayer EGN film has an electrical conductivity of at least about 80 S/cm; and
(iii) the monolayer EGN film has a transparency in the visible electromagnetic spectrum of at least about 25%.

2. The film of claim 1, wherein the thickness ranges from about 0.3 nm to about 10 nm.

3. The film of claim 1, wherein (i) the electrical conductivity is at least about 100 S/cm and (ii) the transparency is at least about 50% at a wavelength of about 500 nm.

4. The film of claim 1, wherein the monolayer EGN film has a carbon content of at least about 90 wt % and an oxygen content of about 10 wt. % or less.

5. The film of claim 1, wherein the EGN film is in the form of the monolayer EGN film.

6. The film of claim 1, wherein the EGN film is in the form of the multilayer EGN film.

7. The film of claim 1, wherein the EGN film is in the form of a free-standing film.

8. The film of claim 1, wherein the EGN film is coated on a substrate, the substrate comprising a second polyelectrolyte deposited on a surface of the substrate, the second polyelectrolyte being oppositely charged to the first polyelectrolyte.

9. The film of claim 1, wherein the EGN film is a component of an optoelectronic device.

10. The film of claim 1, wherein the EGN film is a component of an energy storage device.

11. An exfoliated graphite nanoparticle (EGN) film comprising:
(a) a monolayer EGN film comprising exfoliated graphite nanoparticles, or (b) a multilayer EGN film comprising a plurality of the monolayer EGN films arranged in a layered configuration;
wherein:
(i) the monolayer EGN film has a thickness ranging from about 0.2 nm to about 20 nm;
(ii) the monolayer EGN film has an electrical conductivity of at least about 100 S/cm; and
(iii) the monolayer EGN film has a transparency in the visible electromagnetic spectrum of at least about 35%.

12. The film of claim 11, wherein the thickness ranges from about 0.3 nm to about 10 nm.

13. The film of claim 11, wherein (i) the electrical conductivity is at least about 500 S/cm and (ii) the transparency is at least about 50% at a wavelength of about 500 nm.

14. The film of claim 11, wherein the monolayer EGN film has a carbon content of at least about 90 wt % and an oxygen content of about 10 wt. % or less.

15. The film of claim 11, wherein the EGN film is in the form of the monolayer EGN film.

16. The film of claim 11, wherein the EGN film is in the form of the multilayer EGN film.

17. The film of claim 11, wherein the EGN film is in the form of a free-standing film.

18. The film of claim 11, wherein the EGN film is coated on a substrate.

19. The film of claim 11, wherein the EGN film is a component of an optoelectronic device.

20. The film of claim 11, wherein the EGN film is a component of an energy storage device.

21. A process for forming a nanoparticle film-coated substrate, the process comprising:
providing a substrate assembly comprising a first substrate and a second substrate at a preselected distance from the first substrate, wherein (i) the first and second substrates define an interstitial space therebetween and (ii) the first substrate further comprises a first polyelectrolyte deposited on a surface of the first substrate facing the interstitial area;
providing a deposition dispersion comprising a liquid medium, a second polyelectrolyte oppositely charged to the first polyelectrolyte, and nanoparticles dispersed therein;
filling the interstitial space with the deposition dispersion; and,
evaporating the liquid medium in the interstitial space, thereby (i) depositing the nanoparticles as a film on the surface of the first substrate having the first polyelectrolyte and (ii) forming a nanoparticle film-coated substrate.

22. The process of claim 21, wherein the first substrate and the second substrate are independently selected from the group consisting of a silicon substrate, a glass substrate, a polymer substrate, a cellulosic substrate, and a metal substrate.

23. The process of claim 21, wherein the liquid medium comprises water.

24. The process of claim 21, wherein the first polyelectrolyte comprises a polystyrene sulfonate salt and the second polyelectrolyte comprises a poly(diallyldimethyl ammonium) salt.

25. The process of claim 21, wherein the nanoparticles are selected from the group consisting of carbon nanotubes, metal nanoparticles, metal oxide nanoparticles, and combinations thereof.

26. The process of claim 21, wherein the nanoparticles comprise exfoliated graphite nanoparticles (EGN).

27. The process of claim 26, wherein the resulting nanoparticle film has an electrical conductivity of at least about 80 S/cm as determined by a two-point impedance probe method and a transparency in the visible electromagnetic spectrum of at least about 25%.

28. The process of claim 21, wherein the preselected distance is sufficiently small so that filling the interstitial space with the deposition dispersion occurs by capillary action.

29. The process of claim 28, wherein the preselected distance ranges from about 10 μm to about 500 μm.

30. The process of claim 21, wherein the deposition dispersion has a concentration of nanoparticles that is sufficiently large so that the resulting nanoparticle film is substantially continuous.

31. The process of claim 30, wherein the concentration is at least about 0.02 wt. % nanoparticles in the deposition dispersion.

32. The process of claim 21, further comprising, prior to evaporating the liquid medium:
orienting the substrate assembly so that a normal vector from the surface of the first substrate having the first polyelectrolyte is substantially aligned with but opposite in direction to gravity.

33. The process of claim 21, wherein the substrate assembly comprises an array of a plurality of substrates in which each substrate comprises the first polyelectrolyte on a surface so that each interstitial space defined by a pair of adjacent substrates is bounded by at least one surface comprising the first polyelectrolyte deposited thereon.

34. A process for forming an exfoliated graphite nanoparticle (EGN) film, the process comprising:
providing a suspension formulation comprising a hydrophobic liquid medium and EGN platelets dispersed therein;
mixing an immiscible, hydrophilic liquid with the suspension formulation; and
concentrating the EGN platelets as a monolayer at a liquid-liquid interface between the hydrophobic liquid and the hydrophilic liquid, thereby forming a free-standing monolayer EGN film.

35. The process of claim 34, wherein the hydrophobic liquid comprises a chlorinated hydrocarbon solvent selected from the group consisting of chloroform, methylene chloride, and combinations thereof.

36. The process of claim 34, wherein the hydrophilic liquid comprises water.

37. The process of claim 34, wherein the EGN platelets have a thickness ranging from about 0.2 nm to about 20 nm and a width ranging from about 1 μm to about 20 μm.

38. The process of claim 34, wherein the EGN platelets have a width-to-thickness aspect ratio of at least about 100.

39. The process of claim 34, wherein the suspension formulation has a concentration of EGN platelets that is sufficiently small to substantially prevent agglomeration and coalescence of the EGN platelets.

40. The process of claim 39, wherein the concentration ranges from about 0.0001 wt. % to about 0.1 wt. % of EGN platelets in the suspension formulation.

41. The process of claim 34, wherein the monolayer EGN film has a close packed structure.

42. The process of claim 34, wherein the monolayer EGN film has an electrical conductivity of at least about 500 S/cm as determined by a two-point impedance probe method and a transparency in the visible electromagnetic spectrum of at least about 25%.

43. The process of claim 34, wherein:
mixing the hydrophilic liquid with the suspension formulation comprises sonicating the hydrophilic liquid and the suspension formulation, thereby forming an emulsion between the hydrophobic liquid and the hydrophilic liquid; and
concentrating the EGN platelets comprises allowing the emulsion to separate, thereby forming separate hydrophobic liquid and hydrophilic liquid phases and accumulating the EGN platelets at the liquid-liquid interface.

44. The process of claim 34, further comprising:
depositing the monolayer EGN film on a substrate, thereby forming an EGN film-coated substrate.

45. The process of claim 44, wherein the substrate is selected from the group consisting of a silicon substrate, a glass substrate, a polymer substrate, a cellulosic substrate, and a metal substrate.

46. The process of claim 44, wherein depositing the EGN platelet monolayer comprises:
pulling the substrate through one liquid phase to the second liquid phase, thereby depositing the monolayer EGN film on the substrate as the substrate passes through the liquid-liquid interface.

47. The process of claim 44, wherein depositing the EGN platelet monolayer comprises:
transferring at least a portion of the monolayer EGN film and the hydrophobic liquid from the liquid-liquid interface to a gas-liquid interface between the hydrophilic liquid and a gaseous external environment;
evaporating the hydrophobic liquid at the gas-liquid interface, leaving the monolayer EGN film at the gas-liquid interface; and,
pulling the substrate through the hydrophilic liquid to the gaseous external environment, thereby depositing the monolayer EGN film on the substrate as the substrate passes through the gas-liquid interface.

48. The process of claim 44, further comprising:
annealing the EGN film-coated substrate; and,
immersing the EGN film-coated substrate in the same or a different hydrophilic liquid until the EGN film separates from the substrate, thereby forming a free-standing monolayer EGN film.

49. The process of claim 44, further comprising:
annealing the EGN film-coated substrate;
repeating the steps of (i) providing a suspension formulation comprising a hydrophobic liquid medium and EGN platelets dispersed therein, (ii) mixing an immiscible, hydrophilic liquid with the suspension formulation, and (iii) concentrating the EGN platelets as a monolayer EGN film at a liquid-liquid interface between the hydrophobic liquid and the hydrophilic liquid; and
depositing and annealing the monolayer EGN film on the EGN film-coated substrate, thereby forming a multilayer EGN film-coated substrate.

50. The process of claim 49, further comprising:
immersing the multilayer EGN film-coated substrate in the hydrophilic liquid until the multilayer EGN film separates from the substrate, thereby forming a free-standing multilayer EGN film.
